(19) United States
(12) Patent Application Publication
(10) Pub. No.: US 2026/0326032 A1
(43) Pub. Date: Oct. 22, 2026

(54) HYDROGEN PURIFICATION SYSTEMS

(71) Applicant: Cummins Emission Solutions Inc., Columbus, IN (US)

(72) Inventors: Vikram Sundararajan, Columbus, IN (US); Dylan Scott Trandal, Columbus, IN (US); Huiling Li, Columbus, IN (US); Matthew K. Volmerding, Columbus, IN (US)

(73) Assignee: Cummins Emission Solutions Inc., Columbus, IN (US)

(21) Appl. No.: 19/182,906

(22) Filed: Apr. 18, 2025

(51) Int. Cl. B01D 53/86; B01D 53/04; B01D 53/26; C25B 1/04; C25B 15/08

(52) U.S. Cl. CPC B01D 53/8696; B01D 53/0462; B01D 53/261; B01D 53/8671; C25B 1/04; C25B 15/083; C25B 15/085; B01D 2257/104; B01D 2257/80; B01D 2258/02; B01D 2259/40009

(57) ABSTRACT

A hydrogen purification system includes at least one controller configured to receive a first outlet signal and a second outlet signal and determine an outlet moisture content based on the first outlet signal and the second outlet signal. The controller is configured to receive an inlet signal and determine an inlet hydrogen mixture temperature based on the inlet signal and determine, using a conversion efficiency lookup table, a conversion efficiency of a deoxidizer based on the inlet hydrogen mixture temperature. The controller is further configured to determine a first amount of moisture stored in a dryer based on an outlet moisture content and the conversion efficiency, and after determining that the first amount of moisture is greater than or equal to a threshold, cause a heater to provide heat to the first amount of moisture.

### TECHNICAL FIELD

The present disclosure relates generally to hydrogen purification systems.

### BACKGROUND

Various applications, such as fuel cells, electrolyzer systems, electronic manufacturing, and hydrogen refueling stations implement hydrogen purification systems. Hydrogen gas may include impurities, and it may be desirable to reduce the impurities. For example, it may be desirable to reduce the impurities to comply with purity regulations. To purify hydrogen gas, the hydrogen gas may be provided to at least one of a deoxidizer to remove oxygen or a dryer to remove moisture.

### SUMMARY

In some applications, hydrogen gas with high moisture levels may be provided to the hydrogen purification system, which may damage the deoxidizer and a desiccant material. In some applications, the dryer may have fixed adsorption and desorption cycle times which may lead to energy efficiency, such as beginning a desorption cycle (e.g., heating) prior to the dryer containing a maximum load of moisture. Over time, a service life of components of the hydrogen purification system may be reduced, and energy may be wasted.

Various embodiments of the present disclosure may address such issues.

At least one aspect of the present disclosure is directed to a hydrogen purification system. The hydrogen purification system includes an electrolyzer configured to produce a hydrogen mixture comprising hydrogen, moisture, and oxygen, a system inlet configured to receive the hydrogen mixture from the electrolyzer, and a deoxidizer configured to receive the hydrogen mixture from the system inlet and remove at least a portion of the oxygen from the hydrogen mixture. The hydrogen purification system also includes a dryer configured to receive a deoxidized hydrogen mixture from the deoxidizer and remove at least a portion of the moisture from the deoxidized hydrogen mixture, the dryer comprising a heater, a system outlet configured to receive a deoxidized and dried hydrogen mixture from the dryer and expel the deoxidized and dried hydrogen mixture, a first inlet sensor positioned at the system outlet, the first inlet sensor configured to provide a first inlet signal associated with a temperature of the hydrogen mixture at the system inlet, and a second inlet sensor positioned at the system inlet, the second inlet sensor configured to provide a second inlet signal associated with a pressure of the hydrogen mixture at the system inlet. The controller is configured to receive the first inlet signal and the second inlet signal and determine an inlet moisture content, and an inlet hydrogen mixture temperature based on the first inlet signal and the second inlet signal. The controller is configured to determine, using a conversion efficiency lookup table, a conversion efficiency of the deoxidizer based on the inlet hydrogen mixture temperature, determine a first amount of moisture stored in the dryer based on the inlet moisture content and the conversion efficiency, and after determining that the first amount of moisture is greater than or equal to a threshold, cause the heater to provide heat to the first amount of moisture.

In one embodiment, which may be combined with any of the above embodiments in any combination, the hydrogen purification system further includes a first outlet sensor positioned at the system outlet, the first outlet sensor configured to provide a first outlet signal associated with a temperature of the deoxidized and dried hydrogen mixture at the system outlet and a second outlet sensor positioned at the system outlet, the second outlet sensor configured to provide a second outlet signal associated with a pressure of the deoxidized and dried hydrogen mixture at the system outlet. The controller can be further configured to receive the first outlet signal and the second outlet signal and determine an outlet moisture content based on the first outlet signal and the second outlet signal, determine a hydrogen mixture flow rate based on a production rate of the hydrogen mixture by the electrolyzer, and determine an initial amount of moisture stored in the dryer based on the outlet moisture content prior to receiving the first inlet signal or the second inlet signal. The first amount of moisture can be determined based on the inlet moisture content, the conversion efficiency, the hydrogen mixture flow rate, and the initial amount of moisture.

In one embodiment, which may be combined with any of the above embodiments in any combination, the hydrogen purification system can include a chiller configured to receive at least a portion of the deoxidized hydrogen mixture from the dryer while the heater is providing the heat and chill the portion of the deoxidized hydrogen mixture. The hydrogen purification system can include a demister configured to receive a portion of the deoxidized hydrogen mixture from the dryer while the heater is providing the heat and separate recycled hydrogen from the portion of the deoxidized hydrogen mixture and a compressor configured to receive at least a portion of the recycled hydrogen from the demister and provide the at least the portion of the recycled hydrogen to at least one of the deoxidizer or the dryer. The hydrogen purification system can include a flow meter positioned at the compressor, the flow meter configured to measure a recycled flow rate of the at least the portion of the recycled hydrogen, a first recycled hydrogen sensor positioned at the compressor, the first recycled hydrogen sensor configured to provide a first recycled hydrogen signal associated with a recycled hydrogen pressure, and a second recycled hydrogen sensor positioned at the compressor, the second recycled hydrogen sensor configured to provide a second recycled hydrogen signal associated with a recycled hydrogen temperature.

In one embodiment which may be combined with any of the above embodiments in any combination, the controller is further configured to receive the recycled flow rate from the flow meter and receive the first recycled hydrogen signal from the first recycled hydrogen sensor and determine the recycled hydrogen pressure based on the first recycled hydrogen signal. The controller can be configured to receive the second recycled hydrogen signal from the second recycled hydrogen sensor and determine the recycled hydrogen temperature based on the second recycled hydrogen signal, determine a recycled hydrogen moisture content based on the recycled hydrogen pressure, the recycled hydrogen temperature, and the recycled flow rate of the recycled hydrogen, and determine the first amount of moisture stored in the dryer based on the hydrogen mixture flow rate, the inlet moisture content, the conversion efficiency, the initial amount of moisture, and the recycled hydrogen moisture content.

In one embodiment which may be combined with any of the above embodiments in any combination, the controller can be further configured to determine an adsorption cycle time of the dryer based on the hydrogen mixture flow rate, the inlet moisture content, the conversion efficiency of the deoxidizer, the initial amount of moisture, and the recycled hydrogen moisture content and after determining that the first amount of moisture is less than the threshold, determine a regeneration cycle time based on the adsorption cycle time.

In one embodiment which may be combined with any of the above embodiments in any combination, the dryer includes a dryer inlet configured to receive the deoxidized hydrogen mixture from the deoxidizer, a dryer outlet configured to expel the deoxidized and dried hydrogen mixture, a first dryer sensor positioned at the dryer inlet configured to provide a first dryer signal associated with a dryer inlet temperature, and a second dryer sensor positioned at the dryer outlet configured to provide a second dryer signal associated with a dryer outlet temperature. The chiller can include a first chiller sensor located at the chiller, the first chiller sensor configured to provide a first chiller signal associated with a first chiller temperature of the portion of the deoxidized hydrogen mixture and a second chiller sensor located at the chiller, the second chiller sensor configured to provide a second chiller signal associated with a second chiller temperature of the portion of the deoxidized and chilled hydrogen mixture. The demister can include a demister sensor located in the demister; the demister sensor configured to provide a demister level signal associated with a level of water in the demister.

In one embodiment which may be combined with any of the above embodiments in any combination, the controller can be further configured to receive the first dryer signal and determine the dryer inlet temperature based on the first dryer signal and receive the second dryer signal and determine the dryer outlet temperature based on the second dryer signal. The controller can be configured to receive the first chiller signal and determine the temperature of the portion of the deoxidized hydrogen mixture based on the first chiller signal and the second chiller signal and determine the temperature of the portion of the deoxidized and chilled hydrogen mixture based on the second chiller signal. The controller can be configured to receive the demister level signal and determine the level of water in the demister based on the demister level signal, determine a saturation temperature difference based on the dryer inlet temperature and the dryer outlet temperature. The controller can be configured to determine a chiller temperature difference based on the first chiller temperature and the second chiller temperature and determine whether regeneration of the dryer is complete based on at least one of the adsorption cycle time, the saturation temperature difference, the chiller temperature difference, the level of water in the demister, the hydrogen mixture flow rate, or the first amount of moisture.

In one embodiment which may be combined with any of the above embodiments in any combination, to determine whether regeneration of the dryer is complete, the controller is further configured to determine a regeneration time difference between an initial time value corresponding to a start of the regeneration and a first time value corresponding to an ongoing regeneration and compare the regeneration time difference to a regeneration time threshold. The controller can be configured to determine whether the dryer outlet temperature is proximate than the dryer inlet temperature. The controller can be configured to compare the chiller temperature difference to a chiller temperature difference threshold and receive the demister level signal at the initial time value and determine an initial level of water in the demister based on the demister level signal. The controller can be configured to receive the demister level signal at the first time value and determine a first level of water in the demister based on the demister level signal, determine a demister level difference based on the initial level of water and the first level of water, and compare the demister level difference to a demister level difference threshold. The controller can be further configured to determine a cycle time difference based on a difference between the regeneration time difference and the adsorption cycle time, compare the cycle time difference to a cycle time difference threshold, and after determining that the regeneration time difference is greater than the regeneration time threshold, the demister level difference is less than the demister level difference threshold, the dryer outlet temperature is greater than the dryer inlet temperature, the chiller temperature difference is less than the chiller temperature difference threshold, and the cycle time difference is greater than the cycle time difference threshold, determine that regeneration is complete and decrease the temperature of the heater to initiate adsorption of the dryer.

In one embodiment which may be combined with any of the above embodiments in any combination, after determining that the regeneration time difference is less than or equal to the regeneration time threshold, the demister level difference is greater than or equal to the demister level difference threshold, the dryer outlet temperature is less than the dryer inlet temperature, the chiller temperature difference is greater than or equal to the chiller temperature difference threshold, or the cycle time difference is less than or equal to the cycle time difference threshold, the controller can determine that regeneration is incomplete and maintaining the temperature of the heater to continue regeneration of the dryer.

In one embodiment which may be combined with any of the above embodiments in any combination, the controller can store a first count associated with a complete regeneration and a second count associated with an incomplete regeneration. The controller can be configured to after determining that the regeneration is incomplete, increase the second count by one, and after determining that the regeneration is complete, increase the first count by one. The controller can determine a second amount of moisture stored in the dryer based on the hydrogen mixture flow rate, the inlet moisture content, the conversion efficiency, the initial amount of moisture, and the recycled hydrogen moisture content and store the second amount of moisture and the cycle time difference. The controller can be configured to determine a regeneration efficiency based on the cycle time difference, the first amount of moisture, and the initial amount of moisture, and store the regeneration efficiency.

In one embodiment which may be combined with any of the above embodiments in any combination, the controller is further configured to determine the threshold by determining a regeneration time and a regeneration temperature for the regeneration of the dryer, determining an age of the dryer based on the regeneration time, and determining the threshold based on the regeneration time, the regeneration temperature, and the age of the dryer.

At least one aspect of the present disclosure is directed to a system. The system includes an electrolyzer configured to produce a hydrogen mixture comprising hydrogen, moisture, and oxygen and a hydrogen purification system configured to remove at least a portion of moisture and oxygen from the hydrogen mixture. The hydrogen purification system includes an inlet configured to receive the hydrogen mixture from the electrolyzer, a deoxidizer configured to receive the hydrogen mixture from the inlet and remove at least a portion of the oxygen from the hydrogen mixture, and a dryer configured to receive a deoxidized hydrogen mixture from the deoxidizer and remove at least a portion of the moisture from the at least the deoxidized hydrogen mixture. The hydrogen purification system includes an outlet configured to receive at least a deoxidized and dried hydrogen mixture from the dryer and expel the deoxidized and dried hydrogen mixture, and a first outlet sensor positioned closer to the outlet than the inlet, the first outlet sensor configured to provide a first outlet signal associated with at least one of an oxygen content or a dew point of a portion of the hydrogen mixture. The hydrogen purification system includes a valve operable between a first position and a second position, the valve configured to facilitate flow of the hydrogen mixture to the dryer in the first position, the valve configured to facilitate the flow of the hydrogen mixture to the deoxidizer in the second position. The system includes a controller. The controller is configured to receive the first outlet signal and determine the oxygen content based on the first outlet signal, compare the oxygen content to an oxygen content threshold, after determining that the oxygen content is less than or equal to the oxygen content threshold, causing the valve to be in the first position, and after determining that the oxygen content is greater than the oxygen content threshold, causing the valve to be in the second position.

In one embodiment which may be combined with any of the above embodiments in any combination, the system further includes a vent configured to expel the hydrogen mixture located upstream of the deoxidizer. The valve can be operable between the first position, the second position, and a third position, the valve configured to facilitate the flow of the hydrogen mixture to the vent in the third position. The controller can be further configured to receive the first outlet signal and determine the dew point based on the first outlet signal, and after determining that the dew point is greater than a dew point threshold, cause the valve to be in the third position.

In one embodiment which may be combined with any of the above embodiments in any combination, the hydrogen purification system can further include a demister configured to receive a portion of the deoxidized hydrogen mixture from the dryer and separate moisture and hydrogen from the portion of the deoxidized hydrogen mixture, a first demister sensor positioned at the demister, the first demister sensor configured to provide a first demister signal associated with a demister temperature, and a second demister sensor positioned downstream of the demister, the second demister sensor configured to provide a second demister signal associated with a demister pressure. The controller can be configured to receive the first demister signal and determine the demister temperature based on the first demister signal after causing the valve to be in the second position, and receive the second demister signal and determine the demister pressure based on the second demister signal.

In one embodiment which may be combined with any of the above embodiments in any combination, the hydrogen purification system further includes a first inlet sensor positioned at the inlet, the first inlet sensor configured to provide a first inlet signal associated with a pressure of the hydrogen mixture at the inlet, a second inlet sensor positioned at the inlet, the second inlet sensor configured to provide a second inlet signal associated with an oxygen content of the hydrogen mixture at the inlet, and a deoxidizer sensor positioned at the deoxidizer, the deoxidizer sensor configured to provide a deoxidizer signal associated with a deoxidizer pressure. The controller can be configured to receive the first inlet signal and determine an inlet pressure based on the first inlet signal, receive the second inlet signal and determine the inlet oxygen content based on the second inlet signal, and receive the deoxidizer signal and determine the deoxidizer pressure based on the deoxidizer signal.

In one embodiment which may be combined with any of the above embodiments in any combination, the controller can be further configured to determine a demister efficiency based on the demister pressure and the demister temperature, determine an inlet moisture content based on the demister temperature, the demister efficiency, and the inlet pressure, and determine a total moisture content based on the inlet moisture content and the inlet oxygen content. The controller can be further configured to determine a saturation temperature, using a saturation temperature lookup table, based on the total moisture content and the deoxidizer pressure, determine a deoxidizer target temperature based on a summation of the saturation temperature and a first value associated with an inlet temperature tolerance, and set the deoxidizer to the deoxidizer target temperature.

In one embodiment which may be combined with any of the above embodiments in any combination, the dryer further comprises a heater to provide heat to moisture stored in the dryer and the hydrogen purification system further includes a volumetric flow rate sensor positioned at the inlet, the volumetric flow rate sensor configured to provide a velocity signal associated with a velocity of the hydrogen mixture. The controller can store a target oxygen content of the hydrogen mixture. The controller can be further configured to determine a target conversion efficiency of the deoxidizer by determining a ratio between the inlet oxygen content and the target oxygen content, receive the velocity signal and determine the velocity of the hydrogen mixture based on the velocity signal, and determine, using an inlet temperature lookup table, a saturation temperature of the deoxidized hydrogen mixture based on the velocity and the target conversion efficiency. The controller can be further configured to after determining that the saturation temperature is less than the deoxidizer target temperature, set the heater to the deoxidizer target temperature, and after determining that the deoxidizer target temperature is less than the saturation temperature, set the heater to the saturation temperature.

In one embodiment which may be combined with any of the above embodiments in any combination, the controller is further configured to cause the valve to be in the third position after determining that the deoxidizer target temperature is greater than a temperature threshold.

In one embodiment which may be combined with any of the above embodiments in any combination, the controller can be further configured to determine at least one of an adsorption cycle time or a regeneration cycle time based on the total moisture content.

In one embodiment which may be combined with any of the above embodiments in any combination, the system can further include a flow channel fluidically coupled to the inlet and the first outlet sensor, the flow channel configured to deliver the portion of the hydrogen mixture to the first outlet sensor for the first outlet sensor to provide the first outlet signal.

### BRIEF DESCRIPTION OF THE DRAWINGS

The foregoing and other features of the present disclosure will become more fully apparent from the following description and appended claims taken in conjunction with the accompanying drawings. Understanding that these drawings depict only several implementations in accordance with the disclosure and are therefore not to be considered limiting of its scope, the disclosure will be described with additional specificity and detail through use of the accompanying drawings.

FIG. 1 is a block schematic diagram of an example system;

FIG. 2 is a block schematic diagram of an example hydrogen purification system;

FIG. 3 is a block schematic diagram of another example hydrogen purification system;

FIGS. 4-11 illustrate a flow chart for an example hydrogen purification process that may be implemented in the system shown in FIG. 1; and

FIGS. 12-15 illustrate a flow chart for another example hydrogen purification process that may be implemented in the system shown in FIG. 1.

Reference is made to the accompanying drawings throughout the following detailed description. In the drawings, similar symbols typically identify similar components unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

### DETAILED DESCRIPTION

Following below are more detailed descriptions of various concepts related to, and implementations of hydrogen purification systems. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Hydrogen purification systems (e.g., hydrogen purifiers, hydrogen filters, etc.) remove contaminants from hydrogen gas. The contaminants in hydrogen gas can include oxygen and water (e.g., moisture), and an amount of contaminants in the hydrogen gas can depend on a source of the hydrogen production (e.g., an electrolyzer), environmental conditions (e.g., temperature, pressure), etc.

Applications that use hydrogen gas can have different requirements for a degree of purity of the hydrogen gas. Various components of the hydrogen purification system, such as a dryer, may be preconfigured to initiate adsorption and desorption at specific time intervals, resulting in energy inefficiency. For example, providing hydrogen gas to a deoxidizer that is at or below an oxygen content threshold (e.g., determined by the degree of purity) or causing a heater of the dryer to increase a temperature when the dryer is not at maximum capacity can both accelerate aging of the various components and cause energy inefficiencies in the hydrogen purification system.

Implementations herein are directed to embodiments of at least one of a system or a hydrogen purification system including an electrolyzer, a deoxidizer, a dryer, a plurality of sensors, and a controller. The controller is configured to determine an amount of moisture in the dryer at any one time and to cause a heater of the dryer to provide heat to the amount of moisture in the dryer after determining that the amount of moisture is greater than equal to a threshold (e.g., maximum capacity of the dryer). The at least one of a system or a hydrogen purification system can also include a valve. The controller can determine an oxygen content of the hydrogen gas provided by the electrolyzer at an inlet of a hydrogen purification system. Depending on the oxygen content, the controller can use the valve to direct the hydrogen gas to the deoxidizer or the dryer.

Through these features, implementations described herein are capable of automatically initiating regeneration of the dryer by the controller continually calculating the amount of moisture in the dryer. The controller can also mitigate unnecessary energy expenditure by determining at least the oxygen content of the hydrogen gas at the inlet of the hydrogen purification system, and directing the hydrogen gas based on the requirements of the application. As a result, implementations described herein are capable of reducing costs associated with energy usage and replacements, and can also improve performance of the system by dynamically adjusting the energy expenditure of the hydrogen purification system.

### II. Overview of Example System

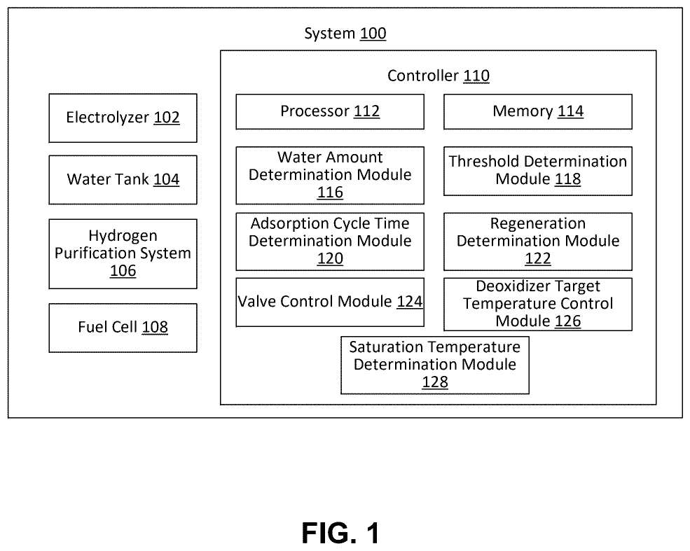

FIG. 1 illustrates an example system 100 (e.g., vehicle system, process plant, etc.) The system 100 includes an electrolyzer 102 (e.g., electrolysis cell, hydrogen generator, etc.) that splits water into hydrogen and oxygen. The system 100 also includes a water tank 104 (e.g., storage tank, etc.). The electrolyzer 102 is configured to (e.g., structured to, able to, etc.) produce a hydrogen mixture (e.g., hydrogen, water, and oxygen, green hydrogen, etc.). The electrolyzer 102 receives water from, for example, the water tank 104 and applies an electric current to the water to separate the water molecules. The water tank 104 is configured to be replenished (e.g., by a user, etc.) and store water.

The system 100 also includes a hydrogen purification system 106 (e.g., hydrogen purifier, etc.) The hydrogen purification system 106 is configured to receive the hydrogen mixture produced by the electrolyzer 102 and to purify the hydrogen mixture into hydrogen. The hydrogen mixture may contain trace contaminants such as oxygen and moisture (e.g., water, H₂O, etc.). The hydrogen purification system 106 is configured to expel the hydrogen. The hydrogen can be used in, for example, at least one fuel cell 108 of the system 100. The fuel cell 108 is configured to combine the hydrogen and oxygen to generate electricity and provide power. In various embodiments, the hydrogen purification system 106 expels the hydrogen into a hydrogen tank of the system 100.

At least the hydrogen purification system 106 is electrically or communicatively coupled to a controller 110. The controller 110 is configured to control the hydrogen purification system 106 and a purification process of the hydrogen purification system 106.

The controller 110 includes a processor 112 and a memory 114. The processor 112 may include a microprocessor, an application-specific integrated circuit (ASIC), a field-programmable gate array (FPGA), etc., or combinations thereof. The memory 114 may include, but is not limited to, electronic, optical, magnetic, or any other storage or transmission device capable of providing a processor, ASIC, FPGA, etc. with program instructions. This memory 114 may include a memory chip, Electrically Erasable Programmable Read-Only Memory (EEPROM), Erasable Programmable Read Only Memory (EPROM), flash memory, or any other suitable memory from which the controller 110 can read instructions. The instructions may include code from any suitable programming language. The memory 114 may include various modules that include instructions which are configured to be implemented by the processor 112.

Control of various components of the system 100 may be split between a plurality of controllers. In various embodiments, the controller 110 controls each component of the system 100, such as the electrolyzer 102.

### III. Overview of Example Hydrogen Purification Systems

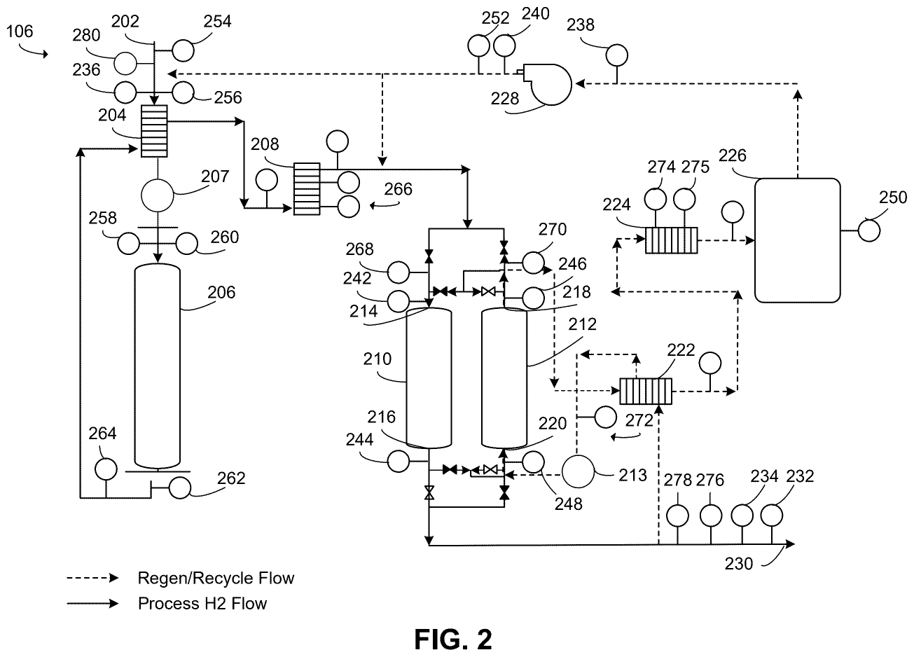

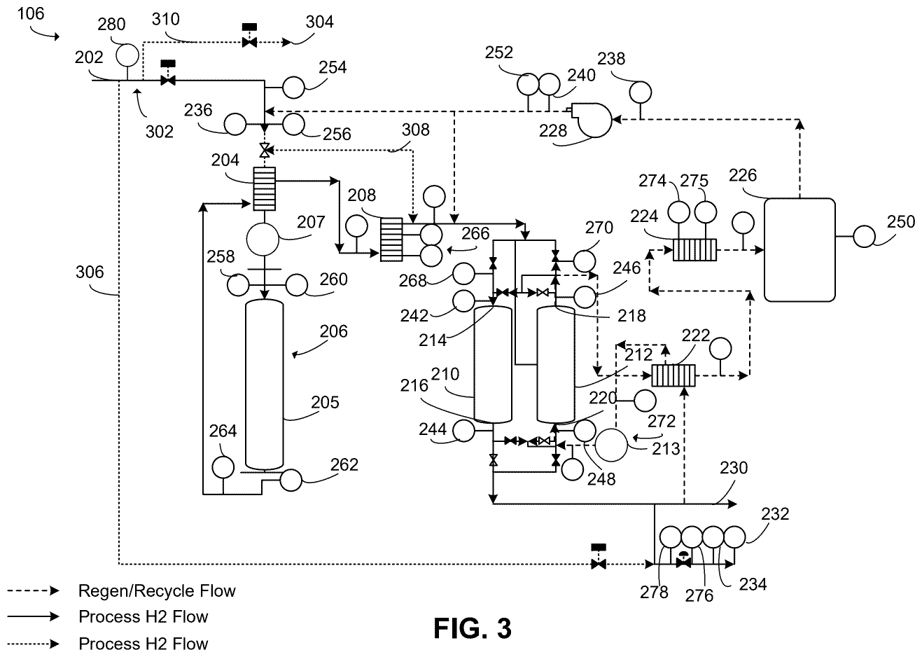

FIGS. 2-3 illustrate example hydrogen purification systems 106. The hydrogen purification system 106 includes an inlet 202 (e.g., system inlet, etc.). The inlet 202 is configured to receive a hydrogen mixture (e.g., moisture, hydrogen, oxygen) from the electrolyzer 102. The hydrogen purification system 106 also includes a heat recovery heat exchanger (HX) 204 (e.g., heat recovery system, etc.) downstream from the inlet 202 and configured to receive the hydrogen mixture from the inlet 202 and provide heat to the hydrogen mixture. In various embodiments, the heat recovery HX 204 is configured to heat the hydrogen mixture to a target temperature.

The hydrogen purification system 106 includes a deoxidizer 206 (e.g., oxygen remover, deoxidizer catalyst, etc.) fluidically coupled to the heat recovery HX 204 and configured to remove at least a portion of oxygen from the hydrogen mixture received from the inlet 202 (e.g., via the heat recovery HX 204). The deoxidizer 206 includes a catalyst member 205 (e.g., substrate, etc.). The catalyst member 205 is configured to remove the oxygen via a recombination reaction with the hydrogen mixture, such as 2H₂+O₂→2H₂O. The deoxidizer 206 thus converts oxygen into water vapor to remove the at least the portion of the oxygen from the hydrogen mixture. The deoxidizer 206 can include at least one heater 207 to assist in the conversion. The heater 207 can provide heat in a range of 30 to 50 degrees Celsius. The heater 207 can be located upstream from the catalyst member 205 and downstream of the heat recovery HX 204. The heater 207 can heat the hydrogen mixture prior to providing the hydrogen mixture to the deoxidizer 206 to facilitate conversion of the hydrogen mixture within the catalyst member 205 (e.g., increasing a speed of the recombination reaction). The heater 207 may not be in direct contact with the catalyst member 205. The deoxidizer 206 includes an inlet to receive the hydrogen mixture from the heat recovery HX 204, and an outlet to expel deoxidized hydrogen mixture to the heat recovery HX 204. The deoxidized hydrogen mixture may contain a portion of oxygen. The heat recovery HX 204 then recovers (e.g., removes, extracts, etc.) heat from the deoxidized hydrogen mixture, and reuses (e.g., applies, etc.) the heat to the hydrogen mixture received from the inlet 202. Consequently, the hydrogen mixture is heated prior to provision to the deoxidizer 206 and cooled after deoxidization.

The hydrogen purification system 106 also includes a first chiller 208 (e.g., cooling system, water-cooled chiller, etc.) located downstream of the heat recovery HX 204. The first chiller 208 receives the deoxidized hydrogen mixture from the heat recovery HX 204, and cools the deoxidized hydrogen mixture. In various embodiments, the first chiller 208 is configured to cool the hydrogen mixture to a specific temperature for further processing. In various embodiments, the first chiller 208 uses water as a cooling medium to remove heat form the hydrogen mixture. In such cases, the water absorbs the heat from the hydrogen mixture, and is recycled to release the absorbed heat.

The hydrogen purification system 106 includes at least one dryer. The dryer is configured to receive the deoxidized hydrogen mixture from the deoxidizer 206 (e.g., via the first chiller 208) and removes at least a portion of the moisture from the deoxidized hydrogen mixture. The dryer includes a heater 213 which provides heat to the at least the portion of the moisture to remove the moisture from the deoxidized hydrogen mixture. The heater 213 can provide heat at a fixed temperature in a range between 250 to 300 degrees Celsius. The hydrogen purification system 106 includes a first dryer 210 and a second dryer 212. The first dryer 210 and the second dryer 212 are located downstream of the first chiller 208 and receive deoxidized and chilled hydrogen mixture.

The first dryer 210 includes a first dryer inlet 214 (e.g., first inlet, dryer inlet, etc.) configured to receive the deoxidized and chilled hydrogen mixture from the first chiller 208, and a first dryer outlet 216 (e.g., first outlet, dryer outlet, etc.) configured to expel deoxidized and dried hydrogen mixture. The deoxidized and dried hydrogen mixture may include a portion of oxygen or moisture.

The second dryer 212 includes a second dryer inlet 218 configured to receive the deoxidized and chilled hydrogen mixture from the first chiller 208 and a second dryer outlet 220 configured to expel deoxidized and dried hydrogen mixture. The first dryer 210 and the second dryer 212 remove moisture from the deoxidized and chilled hydrogen via adsorption/desorption using a molecular sieve desiccant (e.g., drying agent, moisture absorbent, etc.)

The first dryer 210 and the second dryer 212 implement temperature swing absorption (TSA). For example, the first dryer 210 and the second dryer 212 are configured to adsorb moisture in a first temperature range (e.g., about 15 degrees Celsius) and desorb moisture (e.g., regeneration, etc.) in a second temperature range (e.g., 180 to 250 degrees Celsius, inclusive). In various embodiments, each of the first dryer 210 and the second dryer 212 is configured to alternate between adsorbing moisture and regeneration. Regeneration includes heating to the second temperature range, desorbing, and cooling back to the first temperature range. During regeneration, moisture stored (e.g., adsorbed moisture load) in the first dryer 210 and the second dryer 212 (e.g., load of the dryer, etc.) is evaporated and removed. The first dryer 210 and the second dryer 212 include at least one heater 213 to heat the first dryer 210 and the second dryer 212 to the second temperature range. The heater 213 can provide heat to both the first dryer 210 and the second dryer 212. For example, the first dryer 210 receives the deoxidized and chilled hydrogen mixture and adsorbs the moisture while the second dryer 212 regenerates. Consequently, a purification process of the hydrogen mixture remains uninterrupted as the second dryer 212 is regenerating and moisture is removed from, for example, the molecular sieve desiccant. The second dryer 212 expels a gas stream including the desorbed moisture. In various implementations, the hydrogen purification system 106 includes a second heater to heat the second dryer 212, and the heater 213 heats the first dryer 210.

The hydrogen purification system 106 includes a second heat recovery HX 222. The gas stream expelled the dryer in regeneration is provided to the second heat recovery HX 222. The second heat recovery HX 222 is fluidically coupled to and located downstream of the dryer in regeneration. For example, the second dryer 212 is in a regeneration mode (e.g., heater 213 is providing heat to the second dryer 212), and the gas steam is provided to the second heat recovery HX 222. The second heat recovery HX 222 recovers heat from the gas steam, and provides the recovered heat back to the second dryer 212. The hydrogen purification system 106 includes a second chiller 224. The second chiller 224 receives the gas steam from the second heat recovery HX 222 and chills the gas steam.

The hydrogen purification system 106 includes a demister 226 (e.g., water separator, etc.). The demister 226 is configured to separate recycled hydrogen and drain water droplets from a chilled gas stream (e.g., a portion of the deoxidized hydrogen mixture) provided by the second chiller 224. The demister 226 is located downstream of the dryer in regeneration. The demister 226 is configured to generate (e.g., expel, produce, etc.) recycled hydrogen (e.g., hydrogen extracted from the gas stream of the dryer in regeneration). The demister 226 stores and drains the water droplets gathered from the chilled gas stream.

The hydrogen purification system 106 includes a compressor 228 (e.g., pump, etc.) The compressor 228 is configured to receive at least a portion of the recycled hydrogen from the demister 226, and provides the at least the portion of the recycled hydrogen to at least one of the deoxidizer 206 or the dryer. The compressor 228 returns the recycled hydrogen to either the deoxidizer 206 or the first dryer 210 and the second dryer 212. For example, the controller 110 controls the compressor 228, and determines the flow rate of hydrogen mixture from the electrolyzer 102 based on, for example, a flow rate sensor. The flow rate can be in a range of 500 to 5000 cubic meters per hour. The flow rate can correspond to and be equal to a production flow rate of the electrolyzer 102. When the electrolyzer 102 is in a lower flow mode (e.g., expelling hydrogen mixture at a lower rate), the compressor 228 sends the recycled hydrogen to the deoxidizer 206 to maintain operating efficiency of the hydrogen purification system 106. The lower flow mode can correspond to a flow rate below 1300 normalized cubic meters per hour. When the electrolyzer 102 is in a medium flow mode, the compressor 228 can send the recycled hydrogen to at least one of the deoxidizer 206 or the first dryer 210 or the second dryer 212. The medium flow mode can correspond to a flow rate between 1300 to 3500 normalized cubic meters per hour. When the electrolyzer 102 is in a higher flow mode, the compressor 228 sends the recycled hydrogen to either the first dryer 210 or the second dryer 212 (e.g., based on which dryer is adsorbing) to reduce pressure drop and optimize energy usage. The higher flow mode can correspond to a flow rate between 3500 to 5000 cubic meters per hour.

To switch between the first dryer 210 and the second dryer 212, the hydrogen purification system 106 includes one or more valves. The controller 110 controls the one or more valves, and changes a position of the valves based on which of the dryers is adsorbing moisture and which is regenerating. For example, when the first dryer 210 is in regeneration, the controller 110 adjusts the valves such that the deoxidized and chilled hydrogen mixture is provided to the second dryer 212, and a gas stream produced by the first dryer 210 is sent to the second heat recovery HX 222.

The hydrogen purification system 106 includes an outlet 230 (e.g., system outlet, etc.) The dryer adsorbing moisture from the deoxidized hydrogen mixture provides deoxidized and dried hydrogen mixture to the outlet 230. For example, the first dryer 210 expels deoxidized and dried hydrogen mixture to the outlet 230 while the second dryer 212 is regenerating. The deoxidized and dried hydrogen mixture includes hydrogen, and in various embodiments includes trace amounts of moisture and oxygen. The outlet 230 is configured to receive and expel the deoxidized and dried hydrogen mixture.

The hydrogen purification system 106 includes a plurality of sensors. For example, the hydrogen purification system 106 includes a first outlet sensor 232 positioned at the outlet 230. The first outlet sensor 232 is configured to provide a first outlet signal associated with a temperature of the deoxidized and dried hydrogen mixture at the outlet 230. The first outlet sensor 232 is electrically or communicatively coupled to the controller 110 and provides the first outlet signal to the controller 110. The first outlet signal includes information on the temperature of the deoxidized and dried hydrogen mixture expelled at the outlet 230.

The hydrogen purification system 106 includes a second outlet sensor 234 positioned at the outlet 230. The second outlet sensor 234 is configured to provide a second outlet signal associated with a pressure of the deoxidized and dried hydrogen mixture at the outlet 230. The second outlet sensor 234 is electrically or communicatively coupled to the controller 110 and provides the second outlet signal to the controller 110. The first outlet signal includes information on the pressure of the deoxidized and dried hydrogen mixture expelled at the outlet 230.

The hydrogen purification system 106 includes a first inlet sensor 236 positioned at the inlet 202. The first inlet sensor 236 is configured to provide a first inlet signal associated with a temperature of the hydrogen mixture at the inlet 202. The first inlet sensor 236 is electrically or communicatively coupled to the controller 110 and provides the first inlet signal to the controller 110. The first inlet signal includes information on the temperature of the hydrogen mixture provided by the electrolyzer 102 as the hydrogen mixture enters the hydrogen purification system 106 via the inlet 202.

The hydrogen purification system 106 includes a first recycled hydrogen sensor 238 positioned at the compressor 228. The first recycled hydrogen sensor 238 is configured to provide a first recycled hydrogen signal associated with a recycled hydrogen pressure. The first recycled hydrogen sensor 238 is electrically or communicatively coupled to the controller 110 and provides the first recycled hydrogen signal indicating a pressure of the recycled hydrogen at the compressor 228. The first recycled hydrogen sensor 238 is positioned downstream or upstream of the compressor 228.

The hydrogen purification system 106 includes a second recycled hydrogen sensor 240 positioned at the compressor 228. The second recycled hydrogen sensor 240 is configured to provide a second recycled hydrogen signal associated with a recycled hydrogen temperature. The second recycled hydrogen sensor 240 is electrically or communicatively coupled to the controller 110 and provides the second recycled hydrogen signal indicating a temperature of the recycled hydrogen at the compressor 228. The second recycled hydrogen sensor 240 is positioned downstream or upstream of the compressor 228.

The hydrogen purification system 106 includes a plurality of dryer sensors located at the at least one dryer. For example, the first dryer 210 includes a first dryer sensor 242 positioned at the first dryer inlet 214. The first dryer sensor 242 is electrically or communicatively coupled to the controller 110 and is configured to provide the controller 110 with a first dryer signal associated with a dryer inlet temperature (e.g., first dryer inlet temperature). The first dryer signal indicates a temperature of the deoxidized hydrogen mixture at the first dryer inlet 214. The first dryer 210 includes a second dryer sensor 244 positioned at the first dryer outlet 216. The second dryer sensor 244 is electrically or communicatively coupled to the controller 110 and is configured to provide the controller 110 with a second dryer signal associated with a dryer outlet temperature (e.g., second dryer outlet temperature). The second dryer signal indicates a temperature of the deoxidized and dried hydrogen mixture at the first dryer outlet 216.

The second dryer 212 includes a third dryer sensor 246 positioned at the second dryer inlet 218. The third dryer sensor 246 is electrically or communicatively coupled to the controller 110 and is configured to provide the controller 110 with a third dryer signal associated with a dryer inlet temperature (e.g., second dryer inlet temperature). The third dryer signal indicates a temperature of the deoxidized hydrogen mixture at the second dryer inlet 218. The second dryer 212 includes a fourth dryer sensor 248 positioned at the second dryer outlet 220. The fourth dryer sensor 248 is electrically or communicatively coupled to the controller 110 and is configured to provide the controller 110 with a fourth dryer signal associated with a dryer outlet temperature (e.g., second dryer outlet temperature). The fourth dryer signal indicates a temperature of the deoxidized and dried hydrogen mixture at the second dryer outlet 220.

In various embodiments, the first dryer sensor 242 and the third dryer sensor 246 are configured to provide the controller 110 with the first dryer signal and the third dryer signal associated with a temperature of the gas stream. For example, when the heater 213 is providing heat to the first dryer 210, the first dryer 210 produces a gas stream provided to the second heat recovery HX 222, and the first dryer sensor 242 provides the controller 110 with the first dryer signal associated with the temperature of the gas stream.

The demister 226 includes a demister sensor 250 located in the demister 226. The demister sensor 250 is electrically or communicatively coupled to the controller 110 and is configured to provide a demister signal associated with a level of water (e.g., amount of moisture, etc.) in the demister 226. In various embodiments, the demister sensor 250 is a plurality of demister sensors. In these cases, the demister signal is associated with at least one of a level of water in the demister 226, a pressure of the demister 226, or a temperature of the demister 226. For example, the demister signal is associated with a pressure of the gas stream in the demister 226.

The hydrogen purification system 106 includes a flow meter 252. The flow meter 252 is positioned at the compressor 228. The flow meter 252 is positioned either upstream or downstream of the compressor 228. The flow meter 252 is configured to measure a recycled flow rate of the portion of the recycled hydrogen provided to the compressor 228. The flow meter 252 is electrically or communicatively coupled to the controller 110 and provides the measured flow rate to the controller 110. The recycled flow rate can be in a range between 0 to 1500 meters cubed per hour.

The hydrogen purification system 106 includes a second inlet sensor 254 positioned at the inlet 202. The second inlet sensor 254 is electrically or communicatively coupled to the controller 110, and provides a second inlet signal associated with an oxygen concentration at the inlet 202 to the controller 110. The second inlet signal indicates a concentration of oxygen in the hydrogen mixture provided by the electrolyzer 102.

The hydrogen purification system 106 includes a third inlet sensor 256 positioned at the inlet 202. The third inlet sensor 256 is electrically or communicatively coupled to the controller 110 and provides a third inlet signal associated with a pressure at the inlet 202 to the controller 110. The third inlet signal indicates a pressure in the hydrogen mixture provided by the electrolyzer 102.

The hydrogen purification system 106 includes a plurality of sensors positioned at the deoxidizer 206. The sensors are positioned either downstream or upstream of the deoxidizer 206. For example, the hydrogen purification system 106 includes a first deoxidizer sensor 258 electrically or communicatively coupled to the controller 110 and configured to provide a first deoxidizer signal associated with a temperature of the hydrogen mixture entering the deoxidizer 206 to the controller 110. The hydrogen purification system 106 includes a second deoxidizer sensor 260 electrically or communicatively coupled to the controller 110 and configured to provide a second deoxidizer signal associated with a pressure of the hydrogen mixture entering the deoxidizer 206 to the controller 110. The hydrogen purification system 106 includes a third deoxidizer sensor 262 electrically or communicatively coupled to the controller 110 and configured to provide a third deoxidizer signal associated with a temperature of the deoxidized hydrogen mixture expelled from deoxidizer 206 to the controller 110. The hydrogen purification system 106 includes a fourth deoxidizer sensor 264 electrically or communicatively coupled to the controller 110 and configured to provide a fourth deoxidizer signal associated with a pressure of the deoxidized hydrogen mixture expelled from deoxidizer 206 to the controller 110.

The hydrogen purification system 106 includes a plurality of first chiller temperature sensors 266 positioned at the first chiller 208. The plurality of first chiller temperature sensors 266 are located downstream, upstream, or in the first chiller 208. The plurality of first chiller temperature sensors 266 are electrically or communicatively coupled to the controller 110 and are configured to provide a first chiller signal associated with a temperature of the deoxidized hydrogen mixture prior to, during, and after chilling via the first chiller 208. The plurality of first chiller temperature sensors 266 provide the first chiller signal to the controller 110.

The hydrogen purification system 106 includes a fifth dryer sensor 268 located at the first dryer inlet 214 of the first dryer 210. The fifth dryer sensor 268 is electrically or communicatively coupled to the controller 110 and is configured to provide a fifth dryer signal associated with a pressure of the deoxidized hydrogen mixture prior to entering the first dryer 210 to the controller 110. The hydrogen purification system 106 includes a sixth dryer sensor 270 located at the second dryer inlet 218 of the second dryer 212. The sixth dryer sensor 270 is electrically or communicatively coupled to the controller 110 and is configured to provide a sixth dryer signal associated with a pressure of the deoxidized hydrogen mixture prior to entering the second dryer 212 to the controller 110.

The hydrogen purification system 106 includes a plurality of second heat recovery sensors 272 positioned downstream and upstream of the second heat recovery HX 222. The plurality of second heat recovery sensors 272 are configured to provide a second heat recovery signal to the controller 110. The second heat recovery signal is a temperature associated with the gas stream prior to and after heat is removed from the gas stream by the second heat recovery HX 222.

The hydrogen purification system 106 includes a first chiller sensor 274 positioned at the second chiller 224. The first chiller sensor 274 is electrically or communicatively coupled to the controller 110 and is configured to provide a first chiller signal associated with a temperature of the gas stream prior to chilling via the second chiller 224.

The hydrogen purification system 106 includes a second chiller sensor 275 positioned at the second chiller 224. The second chiller sensor 275 is electrically or communicatively coupled to the controller 110 and is configured to provide a second chiller signal associated with a temperature of the gas stream during and after chilling via the second chiller 224.

The hydrogen purification system 106 includes a third outlet sensor 276 positioned at the outlet 230. The third outlet sensor 276 is positioned closer to the outlet 230 than the inlet 202. The third outlet sensor 276 is electrically or communicatively coupled to the controller 110 and is configured to provide a third outlet signal associated with a dew point of the deoxidized and dried hydrogen mixture at the outlet 230 to the controller 110. The hydrogen purification system 106 includes a fourth outlet sensor 278 positioned at the outlet 230. The fourth outlet sensor 278 is positioned closer to the outlet 230 than the inlet 202. The fourth outlet sensor 278 is electrically or communicatively coupled to the controller 110 and is configured to provide a fourth outlet signal associated with an oxygen concentration (e.g., oxygen content, etc.) of the deoxidized and dried hydrogen mixture at the outlet 230 to the controller 110.

In various embodiments, as seen in FIG. 3, the hydrogen purification system 106 includes at least one valve 302 (e.g., three-way valve, etc.) The valve 302 is operable between a first position and a second position. The valve 302 is configured to facilitate flow of the hydrogen mixture from the inlet 202 to the dryer adsorbing moisture (e.g., the first dryer 210 or the second dryer 212) in the first position. In the second position, the valve 302 is configured to facilitate flow of the hydrogen mixture from the inlet 202 to the deoxidizer 206. The valve 302 is communicatively or electrically coupled to the controller 110, and the controller 110 can determine (e.g., adjust, control, etc.) a position of the valve 302.

In various embodiments, the system 100 includes a vent 304. The vent 304 is configured to expel the hydrogen mixture provided by the electrolyzer 102. The vent 304 is located upstream of the deoxidizer 206. In various embodiments, the valve 302 is operable between a first position, a second position, and a third position. In the third position, the valve 302 is configured to facilitate the flow of the hydrogen mixture to the vent 304. Consequently, the hydrogen mixture is expelled, and does not enter the deoxidizer 206 or either of the first dryer 210 or the second dryer 212.

In various embodiments, the hydrogen purification system 106 includes a volumetric flow rate sensor 280. The volumetric flow rate sensor 280 is positioned at the inlet 202. The volumetric flow rate sensor 280 is electrically or communicatively coupled to the controller 110 and is configured to provide the controller 110 with a volumetric flow rate signal associated with a volumetric flow rate of the hydrogen mixture at the inlet 202. The volumetric flow rate signal indicates the volumetric flow rate of the hydrogen mixture as the hydrogen mixture enters the hydrogen purification system 106 from the electrolyzer 102.

As shown in FIG. 3, in various embodiments, the hydrogen purification system 106 includes at least one flow channel. The hydrogen purification system 106 includes a first flow channel 306. The first flow channel 306 is fluidically coupled to the inlet 202 and at least one of the outlet sensors (e.g., the first outlet sensor 232, the second outlet sensor 234, the third outlet sensor 276, the fourth outlet sensor 278). The first flow channel 306 is configured to deliver a portion of the hydrogen mixture to the at least one of the outlet sensors for the at least one of the outlet sensors to provide a corresponding outlet signal to the controller 110. The controller 110 determines the position of the valve 302 based on at least one of the outlet signals.

The hydrogen purification system 106 includes a second flow channel 308. The second flow channel 308 fluidically couples the inlet 202 to upstream of the first dryer 210 and the second dryer 212. In the second position, the valve 302 directs the hydrogen mixture from the inlet 202 to the first dryer 210 or the second dryer 212 using the second flow channel 308, thereby bypassing the deoxidizer 206. In various embodiments, the hydrogen purification system 106 includes a third flow channel 310. The third flow channel 310 fluidically couples the inlet 202 to the vent 304. In the third position, the valve 302 directs the hydrogen mixture from the inlet 202 to the vent 304 using the third flow channel 310.

### III. Overview of an Example Controller

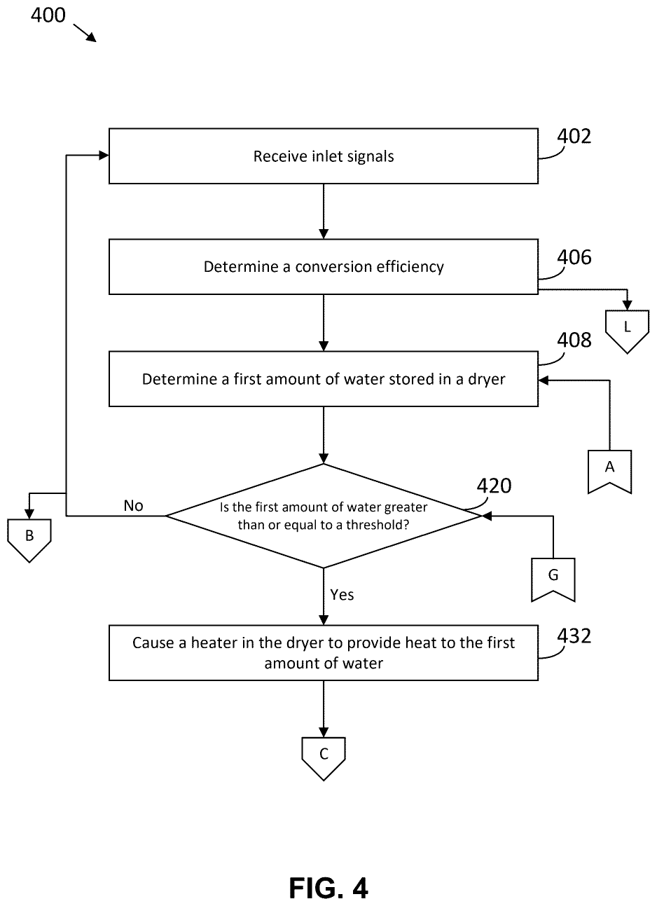

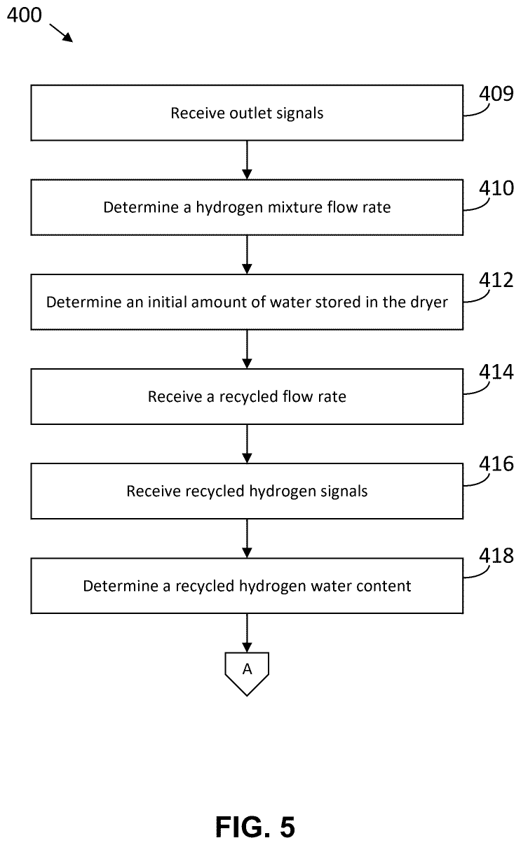

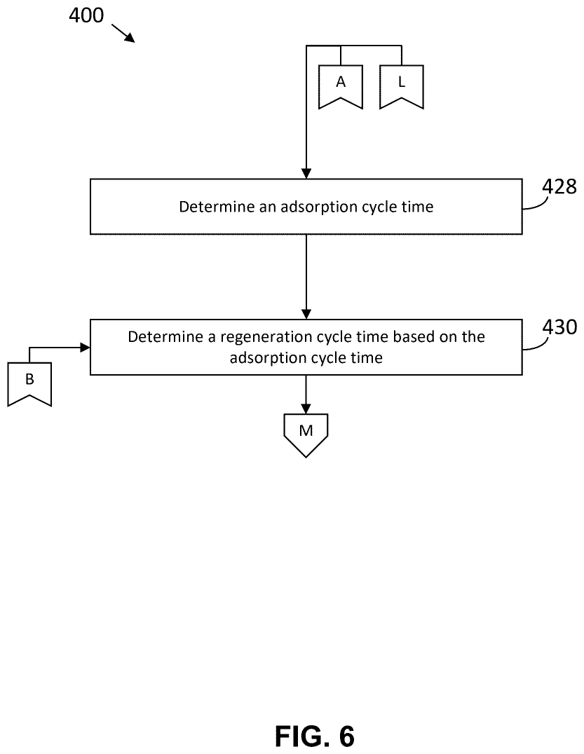

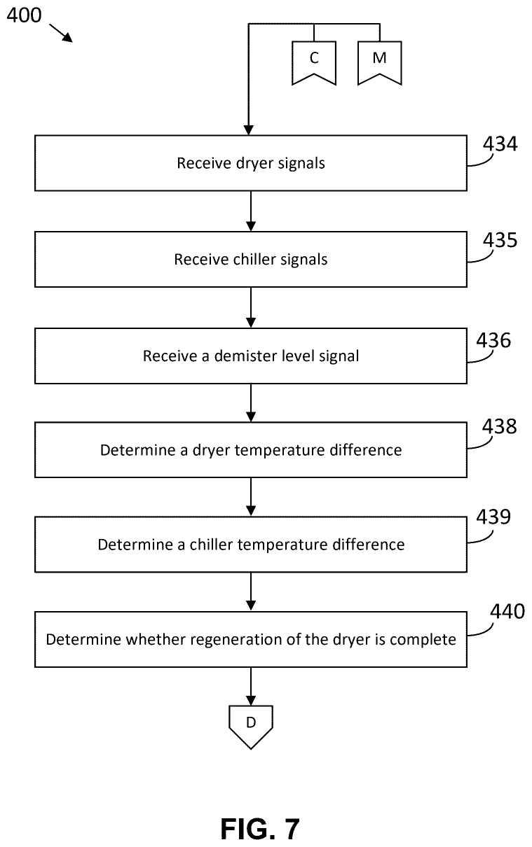

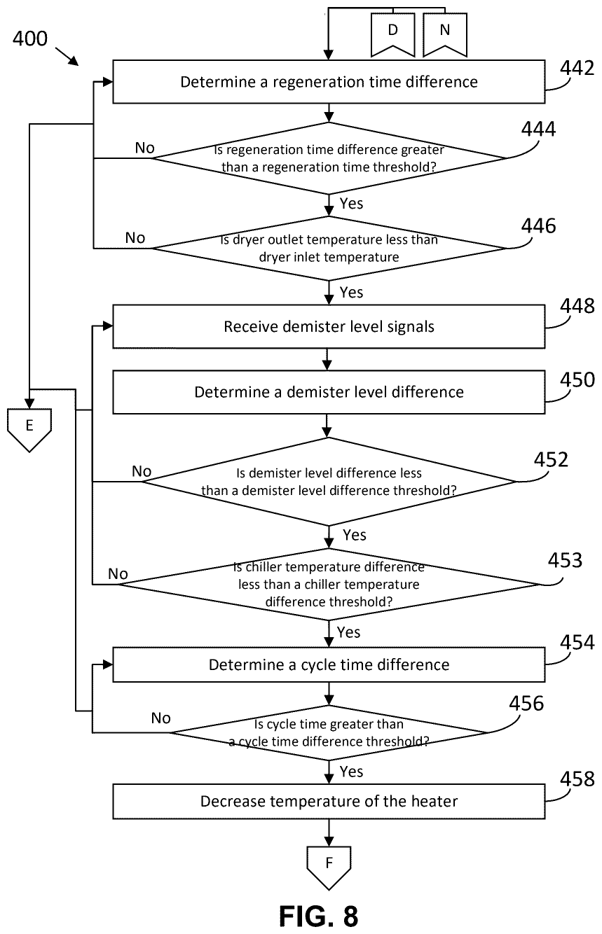

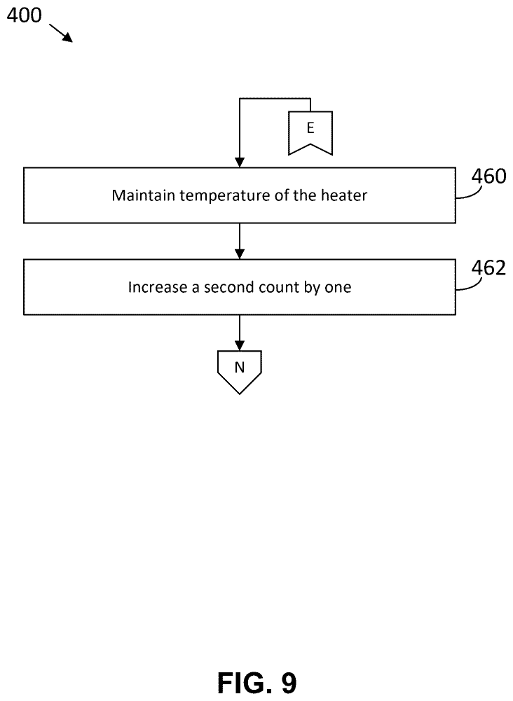

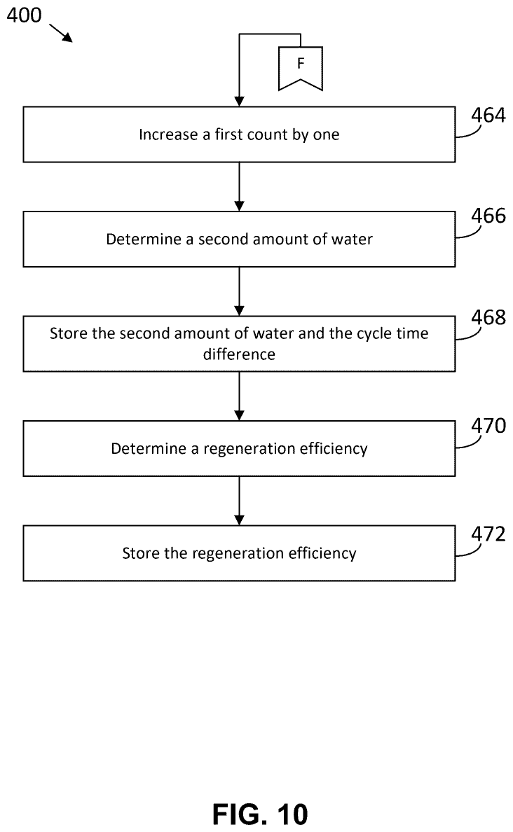

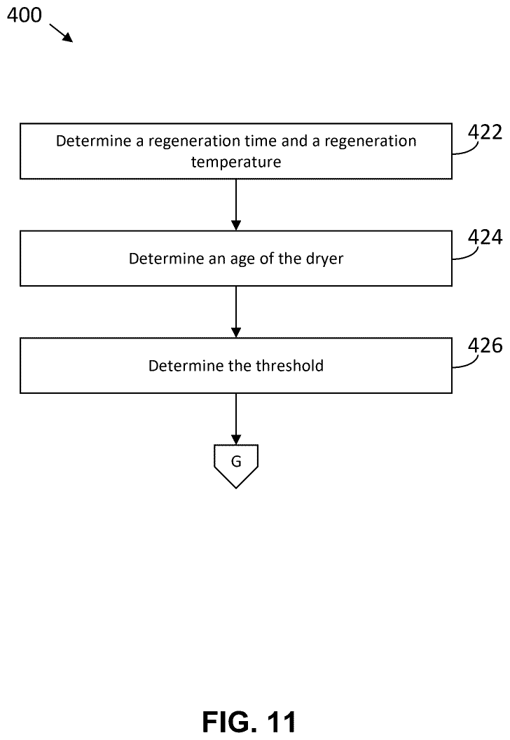

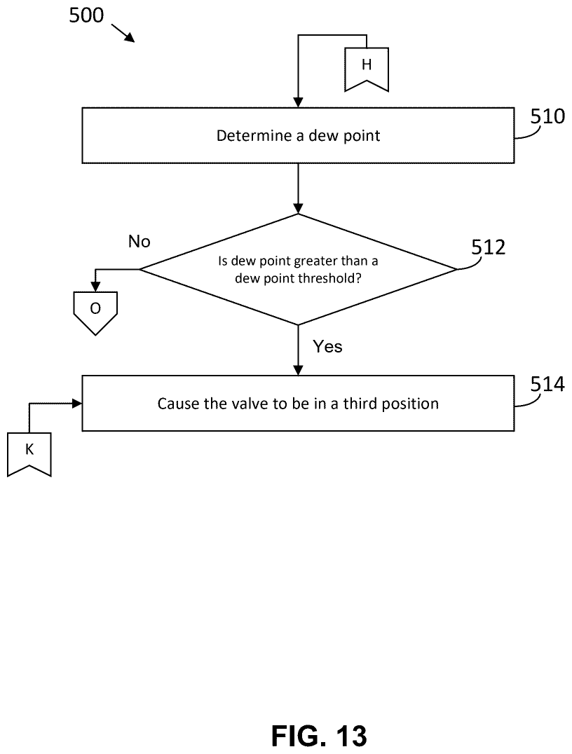

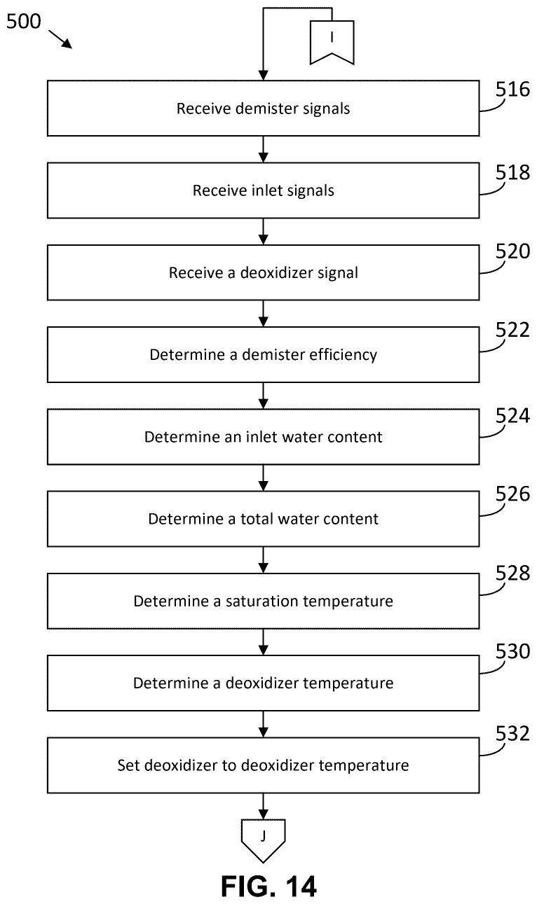

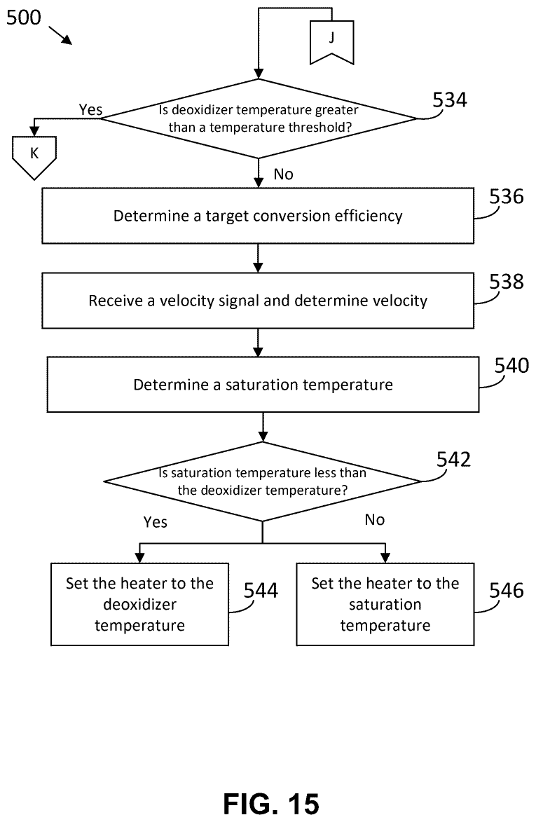

The controller 110 is configured to implement a hydrogen mixture analysis process 400 and a hydrogen mixture analysis process 500, as illustrated in FIGS. 4-15 and discussed in more detail herein, may determine or estimate, for example, a time at which to initiate regeneration of the dryer adsorbing moisture (e.g., the first dryer 210 or the second dryer 212) or to adjust the valve 302 to direct the hydrogen mixture to components of the hydrogen purification system 106 based on at least an oxygen concentration of the hydrogen mixture. To do so, the controller 110 determines a first amount of moisture in the dryer adsorbing moisture based on signals provided by the plurality of sensors of the hydrogen purification system 106, as described in more detail herein. The controller 110 compares the first amount of moisture to a threshold and after determining that the first amount of moisture is greater than or equal to the threshold, causes the heater 213 of the dryer adsorbing moisture to provide heat to the first amount of moisture (e.g., adsorbed moisture load) to remove the moisture from the dryer adsorbing moisture. At least one of the hydrogen mixture analysis process 400 or the hydrogen mixture analysis process 500 described herein is also capable of determining where to direct the hydrogen mixture at the inlet 202, such as to the vent 304, the deoxidizer 206, or the dryer adsorbing moisture as well as when the dryer (e.g., the first dryer 210 or the second dryer 212) is undesirably aged (e.g., in need of service, in need of replacement, etc.).

In these ways and others, the controller 110 implementing at least one of the hydrogen mixture analysis process 400 or the hydrogen mixture analysis process 500 may mitigate undesirable and inefficient operation of the hydrogen purification system 106, by at least controlling regeneration of the dryer adsorbing moisture based on an amount of moisture in the dryer adsorbing moisture, thereby mitigating unnecessary power consumption. As a result, the controller 110 may lengthen regeneration intervals of at least one of the first dryer 210 or the second dryer 212, and reduce power consumption and aging of the at least one of the first dryer 210 or the second dryer 212. The controller 110 can also lengthen service intervals of at least one of the deoxidizer 206, the first dryer 210, or the second dryer 212 by directing the hydrogen mixture depending on at least the oxygen concentration of the hydrogen mixture, thereby reducing servicing, replacement, and warranty costs.

The controller 110 includes a moisture amount determination module 116. The moisture amount determination module 116 determines the first amount of moisture stored in the dryer adsorbing moisture (e.g., the first dryer 210 or the second dryer 212) by receiving the first inlet signal and the second inlet signal from the first inlet sensor 236 and the third inlet sensor 256, respectively. The moisture amount determination module 116 determines an inlet moisture content (e.g., concentration, etc.) and an inlet hydrogen mixture temperature based on the first inlet signal and the second inlet signal. The inlet moisture content can be in a range of 400 to 700 parts per million (ppm). The moisture amount determination module 116 determines the inlet moisture content by comparing the pressure and temperature of the hydrogen mixture at the inlet 202 to a saturation vapor pressure chart. The moisture amount determination module 116 includes a conversion efficiency lookup table. The conversion efficiency lookup table can be based on the recombination reaction of the deoxidizer 206, and relates an amount of moisture to a conversion efficiency of the deoxidizer 206. Using the conversion efficiency lookup table, the moisture amount determination module 116 determines a conversion efficiency of the deoxidizer 206 based on the inlet hydrogen mixture temperature. For example, the moisture amount determination module 116 determines an amount of moisture in the hydrogen mixture at the inlet 202 using a saturation vapor pressure curve based on the inlet hydrogen mixture temperature. The moisture amount determination module 116 then compares the amount of moisture in the hydrogen mixture to the conversion efficiency lookup table to determine the conversion efficiency of the deoxidizer 206. The conversion efficiency can be in a range of 0 to 100 percent, specifically converting oxygen into moisture in a range of 0 to 100 percent. The conversion efficiency indicates an amount of moisture that the deoxidizer 206 converts from oxygen and is then provided to the dryer adsorbing moisture.

The moisture amount determination module 116 receives the first outlet signal and the second outlet signal from the first outlet sensor 232 and the second outlet sensor 234, respectively. The moisture amount determination module 116 determines an outlet moisture content based on the first outlet signal and the second outlet signal. For example, the first outlet signal is associated with a temperature of the deoxidized and dried hydrogen mixture and the second outlet signal is associated with a pressure of the deoxidized and dried hydrogen mixture. The moisture amount determination module 116 compares the pressure and the temperature to a saturation vapor curve to determine the outlet moisture content. The outlet moisture content indicates a moisture content of the deoxidized and dried hydrogen mixture. The outlet moisture content can be less than 5 ppm. The moisture amount determination module 116 determines a hydrogen mixture flow rate based on production rate of the hydrogen mixture by the electrolyzer 102. In various embodiments, the production rate of the electrolyzer 102 is stored in the controller 110. The hydrogen mixture flow rate includes a flow rate of water vapor and hydrogen into the hydrogen purification system 106. The moisture amount determination module 116 determines the hydrogen mixture flow rate based on the production rate using the ideal gas law. The moisture amount determination module 116 determines a number of moles of hydrogen gas and a number of moles of water vapor flowing into the hydrogen purification system 106 based on the production rate.

The moisture amount determination module 116 determines an initial amount of moisture stored in the dryer adsorbing moisture based on the outlet moisture content prior to receiving the first inlet signal or the second inlet signal. For example, the moisture amount determination module 116 determines the initial amount of moisture immediately following the dryer being switched from regeneration to adsorbing moisture. Using the outlet moisture content, the moisture amount determination module 116 estimates the initial amount of moisture.

The moisture amount determination module 116 receives the recycled flow rate from the flow meter 252, the first recycled hydrogen signal from the first recycled hydrogen sensor 238, and the second recycled hydrogen signal from the second recycled hydrogen sensor 240. The moisture amount determination module 116 determines the recycled hydrogen pressure based on the first recycled hydrogen signal and the recycled hydrogen temperature based on the second recycled hydrogen signal. Using the recycled flow rate of the recycled hydrogen, the recycled hydrogen pressure, and the recycled hydrogen temperature, the moisture amount determination module 116 determines a recycled hydrogen moisture content. To do so, the moisture amount determination module 116 uses a saturation vapor pressure chart to determine the moisture ppm, and converts the moisture ppm to the recycled hydrogen moisture content using the recycled flow rate using the ideal gas law. The recycled hydrogen moisture content can be in a range of 400 to 700 ppm.

The moisture amount determination module 116 determines the first amount of moisture stored in the dryer adsorbing moisture based on at least one of the inlet moisture content, the conversion efficiency, the hydrogen mixture flow rate, the initial amount of moisture, or the recycled moisture content. The first amount of moisture (e.g., moisture load, etc.) can be in a range of 40 to 50 kilograms (kg) of moisture. The moisture amount determination module 116 determines an amount of moisture entering the dryer, and estimates the first amount of moisture stored in the dryer. After determining the first amount of moisture, the moisture amount determination module 116 compares the first amount of moisture to a threshold indicative of an amount of moisture to initiate regeneration (e.g., heating) of the dryer. After determining that the first amount of moisture is greater than or equal to the threshold, the moisture amount determination module 116 causes the heater 213 of the dryer to provide heat to the first amount of moisture to remove (e.g., evaporate, etc.) the first amount of moisture from the dryer. After determining that the first amount of moisture is less than the threshold, the moisture amount determination module 116 allows the dryer to continue adsorbing moisture. The moisture amount determination module 116 includes at least one algorithm, model, or function to generate the first amount of moisture. In various embodiments, the moisture amount determination module 116 is implemented as a hardwired circuit.

The controller 110 includes a threshold determination module 118. The threshold determination module 118 determines the threshold for the first amount of moisture, and provides the threshold to the moisture amount determination module 116. The threshold determination module 118 determines a regeneration time and regeneration temperature for the regeneration of at least one of the first dryer 210 or the second dryer 212. For example, to determine the regeneration time, the threshold determination module 118 records a start time and an end time of the regeneration of the dryer. The regeneration time can be in a range between 2 to 8 hours, inclusive. To determine the regeneration temperature, the threshold determination module 118 receives at least one of the first dryer signal, the second dryer signal, the third dryer signal, or the fourth dryer signal, and records the temperature during regeneration of the dryer. Based off the regeneration time, the threshold determination module 118 determines an age (e.g., capacity, etc.) of the dryer. For example, the regeneration time is a regeneration time following an extended adsorption time, and the threshold determination module 118 receives the demister signal and at least one outlet signal to determine the level of water in the demister 226 and the dew point of the oxidized and dried hydrogen mixture at the outlet 230. The threshold determination module 118 compares the level of water and the dew point to a previous level of water and dew point as a result of a previous regeneration time following an extended adsorption time to determine a difference. The threshold determination module 118 determines the age of the dryer based on the age. In various embodiments, the threshold determination module 118 initiates extended adsorption times to test and determine the age of each of the first dryer 210 and the second dryer 212.

Based on the regeneration time, the regeneration temperature, and the age of the dryer, the threshold determination module 118 determines the threshold. Consequently, the threshold may be different between the first dryer 210 and the second dryer 212. The threshold indicates an efficiency, capacity, and age of the dryer as well as a maximum of amount of moisture the dryer can hold and completely regenerate (e.g., zero initial amount of moisture, no moisture remaining in dryer following regeneration, etc.) In various embodiments, the threshold determination module 118 stores a target (e.g., goal, etc.) amount of moisture for the dryer to store, and adjusts the target amount based on the age of a respective dryer to determine the threshold. The threshold determination module 118 includes at least one algorithm, model, or function to generate the threshold. In various embodiments, the threshold determination module 118 is implemented as a hardwired circuit.

The controller 110 includes an adsorption cycle time determination module 120. The adsorption cycle time determination module 120 determines an adsorption cycle time of each of the first dryer 210 and the second dryer 212. The adsorption cycle time can be in a range of 8 to 80 hours, inclusive. The adsorption cycle time determination module 120 determines the adsorption cycle time based on the hydrogen mixture flow rate, the inlet moisture content, the conversion efficiency of the deoxidizer 206, the initial amount of moisture, and the recycled hydrogen moisture content provided by the moisture amount determination module 116. For example, the adsorption cycle time determination module 120 estimates a time at which the first amount of moisture reaches the threshold. In various embodiments, the adsorption cycle time determination module 120 determines the adsorption cycle time based on a capacity of the dryer, which can be determined by the threshold determination module 118, and the hydrogen mixture flow rate. The adsorption cycle time determination module 120 determines the moisture vapor mass flow rate, and divides the moisture vapor flow rate by the dryer capacity to determine the adsorption cycle time.

After determining that the first amount of moisture is less than the threshold, the adsorption cycle time determination module 120 determines a regeneration cycle time based on the adsorption cycle time. The adsorption cycle time determination module 120 sets a time at which to begin regeneration of the dryer based on the adsorption cycle time. In various embodiments, the adsorption cycle time determination module 120 determines a length and temperature of the regeneration cycle based on the adsorption cycle time and a resulting amount of moisture in the dryer at the end of the adsorption cycle time. In other embodiments, the length and temperature of the regeneration cycle is based on the threshold. The adsorption cycle time determination module 120 includes at least one algorithm, model, or function to generate the adsorption cycle time. In various embodiments, the adsorption cycle time determination module 120 is implemented as a hardwired circuit.

The controller 110 includes a regeneration determination module 122. The regeneration determination module 122 determines whether regeneration of the dryer is complete. The regeneration determination module 122 receives the first dryer signal and determines the dryer inlet temperature based on the first dryer signal. The dryer inlet temperature can be in a range between 180 to 300 degrees Celsius, inclusive. The regeneration determination module 122 receives the second dryer signal and determines the dryer outlet temperature based on the second dryer signal. The dryer outlet temperature can be in a range between 15 to 300 degrees Celsius, inclusive. The regeneration determination module 122 receives the demister level signal and determines the level of water in the demister 226 based on the first dryer signal. The level of water can be in a range of 10 to 70 percent of a water storage within the demister 226. The regeneration determination module 122 determines a saturation temperature difference based on the dryer inlet temperature and the dryer outlet temperature. For example, the regeneration determination module 122 subtracts the dryer inlet temperature from the dryer outlet temperature to determine the saturation temperature difference.

The regeneration determination module 122 determines whether regeneration of the dryer (e.g., the dryer in the regeneration cycle, the heater 213 providing heat to the dryer, etc.) based on at least one of the adsorption cycle time, the saturation temperature difference, the level of water in the demister, the hydrogen mixture flow rate, or the first amount of moisture, as described further herein. For example, the regeneration determination module 122 compares a time and length of the regeneration to the first amount of moisture. To determine whether regeneration of the dryer is complete, the regeneration determination module 122 determines a regeneration time difference between an initial time value corresponding to a start of the regeneration and a first time value corresponding to an ongoing regeneration. For example, the regeneration determination module 122 records a time at which regeneration for the dryer began, and determines a time corresponding to an ongoing length (e.g., current time, current length, etc.) of the regeneration for the dryer. The regeneration determination module 122 receives the demister level signal at the initial time value and the first time value, and determines an initial level of water and a first level of water in the demister 226 based on the demister level signal. The regeneration determination module 122 determines a cycle time difference based on a difference between the regeneration time difference and the adsorption cycle time which is, for example, received from the adsorption cycle time determination module 120.

The regeneration determination module 122 stores at least one of a regeneration time threshold, a demister level difference threshold, or a cycle time difference threshold. The regeneration time threshold, the demister level difference threshold, and the cycle time difference threshold are preconfigured or adjusted by the threshold determination module 118 based on, for example, the age of the dryer. For example, the regeneration time threshold increases as the age of the dryer increases. The regeneration determination module 122 determines that regeneration is complete by determining that the regeneration time difference is greater than the regeneration time threshold, the demister level difference is less than the demister level difference threshold, the dryer outlet temperature is greater than the dryer inlet temperature, and the cycle time difference is greater than the cycle time difference threshold. After determining that regeneration is complete, the regeneration determination module 122 decreases the temperature of the heater 213 of the dryer (e.g., first dryer 210) to initiate adsorption of the dryer. In various embodiments, the regeneration determination module 122, in parallel, initiates regeneration of the second dryer (e.g., second dryer 212).

In various embodiments, the regeneration determination module 122 further determines a temperature difference across the second chiller 224 to determine whether regeneration of the dryer is complete. For example, the regeneration determination module 122 receives the second chiller signal and determines a second chilling temperature difference between the temperature of the gas stream prior to and after chilling by the second chiller 224. The temperature of the gas stream prior to and after chilling by the second chiller 224 can correspond to a quantity of moisture in the gas stream. The regeneration determination module 122 stores a second chiller temperature difference threshold, and compares the second chilling temperature difference to the second chiller temperature difference threshold. After determining that the second chilling temperature difference is less than the second chiller temperature difference threshold, the regeneration determination module 122 determines that regeneration of the dryer is complete. In various embodiments, the regeneration determination module 122 determines the second chilling temperature difference instead of the demister level difference to determine whether regeneration is complete. The regeneration determination module 122 can determine which of the second chilling temperature difference or the demister level difference to determined based on a sensitivity of the demister level signals and the second chiller signal. Both the second chilling temperature difference and the demister level difference can correspond to a moisture level in the dryer.

After determining that the regeneration time difference is less than or equal to the regeneration time threshold, the demister level difference is greater than or equal to the demister level difference threshold, the dryer outlet temperature is substantially less than or equal to the dryer inlet temperature (e.g., not within 25 degrees Celsius of the dryer inlet temperature), the cycle time difference is less than or equal to the cycle time difference threshold, or the second chilling temperature difference is greater than or equal to the second chiller temperature difference threshold, the regeneration determination module 122 determines that regeneration in the dryer is incomplete and maintains the temperature of the heater 213 to continue regeneration of the dryer to further remove moisture from the dryer. The regeneration determination module 122 includes at least one algorithm, model, or function to determine regeneration completion. In various embodiments, the regeneration determination module 122 is implemented as a hardwired circuit.

The controller 110 stores a first count and a second count. The first count is associated with a complete (e.g., effective, no remaining moisture, etc.) regeneration and a second count is associated with an incomplete (e.g., ineffective, moisture remaining in dryer, etc.) regeneration. After determining that the regeneration is incomplete, the regeneration determination module 122 increases the second count by one. After determining that the regeneration is complete, the regeneration determination module 122 increases the first count by one. In addition, the regeneration determination module 122 determines (e.g., estimates, etc.) a second amount of moisture stored in the dryer that completed regeneration based on the hydrogen mixture flow rate, the inlet moisture content, the conversion efficiency, the initial amount of moisture, and the recycled hydrogen moisture content. The second amount of moisture corresponds to a load of the dryer at the end of regeneration. The regeneration determination module 122 stores the second amount of moisture and the cycle time difference. The second amount of moisture can be in a range of 2 to 22 kg. The cycle time difference indicates a completion time of the regeneration. Based on the cycle time difference, the first amount of moisture, and the second amount of moisture, the regeneration determination module 122 determines a regeneration efficiency. The regeneration efficiency indicates an efficiency of the dryer in removing moisture. For example, the regeneration efficiency is determined based on a difference between the second amount of moisture and the first amount of moisture, and the cycle time difference. The regeneration efficiency is stored by the regeneration determination module 122 and can be used by, for example, the threshold determination module 118 to determine the age of the dryer.

The controller 110 includes a valve control module 124. The valve control module 124 determines a position of the valve 302. The valve control module 124 receive the first outlet signal and determines an oxygen content of the hydrogen mixture at the inlet 202 based on the first outlet signal. The valve control module 124 stores an oxygen content threshold, and compares the oxygen content to the oxygen content threshold. A user can preset the oxygen content threshold. After determining that the oxygen content is less than or equal to the oxygen content threshold, the valve control module 124 cause the valve to be in the first position, causing the hydrogen mixture to flow to the dryer adsorbing moisture. The oxygen content being less than or equal to the oxygen content threshold indicates that the hydrogen mixture already has a low (e.g., acceptable, etc.) amount of oxygen and thereby does not need oxygen removed, improving efficiency and reducing power consumption of the hydrogen purification system 106. After determining that the oxygen content is greater than the oxygen content threshold, the valve control module 124 cause the valve to be in the second position, causing the hydrogen mixture to flow to the deoxidizer 206.

The valve control module 124 further receives at least one outlet signal, and determines the dew point of the hydrogen mixture based on the first outlet signal. For example, a portion of the hydrogen mixture is provided to at least one outlet sensor (e.g., third outlet sensor 276 and fourth outlet sensor 278) via the first flow channel 306 to provide the at least one outlet signal. The valve control module 124 stores a dew point threshold, and compares the dew point to the dew point threshold. After determining that the dew point is greater than a dew point threshold, the valve control module 124 causes the valve 302 to be in the third position to expel the hydrogen mixture to the vent 304. The valve control module 124 determining that the dew point is greater than a dew point threshold indicates that a moisture content of the hydrogen mixture may be too high for, for example, the dryer to properly remove the moisture content from the hydrogen mixture. The valve control module 124 includes at least one algorithm, model, or function to determine a position of the valve 302. In various embodiments, the valve control module 124 is implemented as a hardwired circuit.

The controller 110 includes a deoxidizer target temperature control module 126. The deoxidizer target temperature control module 126 determines and sets the deoxidizer 206 to a deoxidizer target temperature (e.g., deoxidizer temperature) by setting the heater 207 to the deoxidizer target temperature. The deoxidizer target temperature can be a temperature at which to operate the deoxidizer 206 to perform the recombination reaction, and the deoxidizer target temperature can be adjusted to increase an efficiency of the recombination reaction. After the valve control module 124 causes the valve 302 to be in the second position, the deoxidizer target temperature control module 126 receives the first demister signal and the second demister signal and determines the demister temperature and demister pressure based on the first demister signal and the second demister signal, respectively. The deoxidizer target temperature control module 126 receives the second inlet signal and determines the oxygen concentration (e.g., oxygen content) of the hydrogen mixture at the inlet 202 (e.g., inlet oxygen content). The deoxidizer target temperature control module 126 receives the third inlet signal and determines the pressure of the hydrogen mixture at the inlet 202 (e.g., the inlet pressure). The deoxidizer target temperature control module 126 receives the deoxidizer signal and determines the deoxidizer pressure based on the deoxidizer signal.

To determine the deoxidizer target temperature, the deoxidizer target temperature control module 126 first determines a demister efficiency based on the demister pressure and the demister temperature using a saturation vapor curve. The deoxidizer target temperature control module 126 determines an inlet moisture content based on the demister temperature, the demister efficiency, and the inlet pressure. The inlet moisture content indicates a moisture content of the hydrogen mixture provided by the electrolyzer 102. The deoxidizer target temperature control module 126 determines the inlet moisture content using a saturation vapor curve and including the demister efficiency. The deoxidizer target temperature control module 126 determines a total moisture content based on the inlet moisture content and the inlet oxygen content. For example, the deoxidizer target temperature control module 126 combines the moisture in ppm based on the inlet moisture content, and two times the oxygen in ppm based on the inlet oxygen content to determine the total moisture content.

The deoxidizer target temperature control module 126 determines a saturation temperature (e.g., first saturation temperature) using a saturation temperature lookup table based on the total moisture content and the deoxidizer pressure. The deoxidizer target temperature control module 126 compares the total moisture content and the deoxidizer target temperature to the saturation temperature lookup table, and determines the saturation temperature based on the saturation temperature associated with the total moisture content and the deoxidizer target temperature. The deoxidizer target temperature control module 126 determines a deoxidizer target temperature by adding the saturation temperature to a first value associated with an inlet temperature tolerance (e.g., margin, etc.) The first value may be preset, and is used to ensure that the deoxidizer target temperature is above a desired temperature of the deoxidizer 206, and mitigates undesirable temperature gradients. Once the deoxidizer target temperature control module 126 determines the deoxidizer target temperature, the deoxidizer target temperature control module 126 sets the deoxidizer 206 to the deoxidizer target temperature. The deoxidizer target temperature control module 126 includes at least one algorithm, model, or function to determine the deoxidizer target temperature. In various embodiments, the deoxidizer target temperature control module 126 is implemented as a hardwired circuit.

In various embodiments, the deoxidizer target temperature control module 126 compares the deoxidizer target temperature to a temperature threshold. After determining that the deoxidizer target temperature is greater than or equal to the temperature threshold, the deoxidizer target temperature control module 126 transmits a signal (e.g., message, indication, etc.) to the valve control module 124 to cause the valve 302 to be in the third position. The deoxidizer target temperature being greater than the temperature threshold indicates that the moisture content in the hydrogen mixture is greater than the dryer can adsorb. In various embodiments, the deoxidizer target temperature control module 126 calculates at least one of the adsorption or regeneration cycle time based on the total moisture content. For example, the deoxidizer target temperature control module 126 transmits the total moisture content to the adsorption cycle time determination module 120 and the adsorption cycle time determination module 120 determines the adsorption cycle by predicting the first amount of moisture over time using the total moisture content.

The controller 110 includes a saturation temperature determination module 128. The controller 110 stores a target oxygen content of the hydrogen mixture, which is associated with the oxygen content threshold and may be preset by the user. The saturation temperature determination module 128 determines a target conversion efficiency of the deoxidizer 206 by determining a ratio between the inlet oxygen content and the target oxygen content. In various embodiments, the saturation temperature determination module 128 determines the target conversion efficiency by using the recombination reaction. The saturation temperature determination module 128 further receives the volumetric flow rate signal and determines the volumetric flow rate of the hydrogen mixture. Based on the volumetric flow rate, the saturation temperature determination module 128 determines a velocity of the hydrogen mixture at the inlet 202. For example, the controller 110 stores a cross-sectional area of a pipe of the hydrogen purification system 106 that receives the hydrogen mixture (e.g., the inlet 202), and determines the velocity by dividing the volumetric flow rate by the cross sectional area. In various embodiments, the saturation temperature determination module 128 further receives the inlet signals and determines at least one of a pressure or temperature of the hydrogen mixture at the inlet 202. The saturation temperature determination module 128 can determine the volumetric flow rate based on the ideal gas law. The saturation temperature determination module 128 can determine the deoxidizer target temperature based on the velocity of the hydrogen mixture and the target conversion efficiency.

Based on the velocity and the target conversion efficiency and using an inlet temperature lookup table, the saturation temperature determination module 128 determines a saturation temperature (e.g., second saturation temperature) of the deoxidized hydrogen mixture within the dryer. Specifically, the saturation temperature determination module 128 can determine a saturation temperature of the deoxidized hydrogen mixture based on a pressure and temperature of the hydrogen mixture. For example, the inlet temperature lookup table associates temperature with velocity of the hydrogen mixture. The temperature can be computed through inverse interpolation of the target efficiency and velocity as inputs. In general, as the velocity increases, the conversion efficiency of the deoxidizer 206 decreases and the saturation temperature increases. As the velocity decreases, the conversion efficiency increases and the saturation temperature decreases. In some embodiments, the first saturation temperature is same as the second saturation temperature.

After determining that the saturation temperature is less than the deoxidizer target temperature, the saturation temperature determination module 128 sets the heater 207 to the deoxidizer target temperature. The deoxidizer target temperature can be a temperature at which the deoxidizer 206 provides maximum conversion efficiency (e.g., of oxygen into moisture). After determining that the deoxidizer target temperature is less than the saturation temperature, the saturation temperature determination module 128 sets the heater 213 to the saturation temperature. This is done to improve energy efficiency by prioritizing efficiency of the deoxidizer over power consumption of the heater 213.

### IV. Overview of an Example Hydrogen Mixture Analysis Process

FIGS. 4-11 illustrate an example of the hydrogen mixture analysis process 400 (e.g., method, procedure, etc.) implemented in the system 100. The hydrogen mixture analysis process 400 starts by receiving inlet signals at block 402. The controller 110 may receive any number of inlet signals from the inlet sensors. For example, the inlet signals include the inlet outlet signal associated with the temperature of the hydrogen mixture at the inlet 202 and the second inlet signal associated with the pressure of the hydrogen mixture at the inlet 202. The moisture amount determination module 116 determines the inlet moisture content is determined based on the pressure and the temperature using, for example, a saturation vapor curve. The moisture amount determination module 116 determines an inlet hydrogen mixture temperature based on the temperature of the hydrogen mixture at the inlet 202.

The hydrogen mixture analysis process 400 continues at block 406 with determining the conversion efficiency of the deoxidizer. The moisture amount determination module 116 determines the conversion efficiency using the conversion efficiency table based on the inlet hydrogen mixture temperature. For example, the deoxidizer uses a recombination reaction to separate the oxygen from the hydrogen mixture, and an efficiency of the recombination reaction is correlated with the inlet hydrogen mixture temperature.

After determining the conversion efficiency, at block 408, the hydrogen mixture analysis process 400 includes determining a first amount of moisture stored in the dryer. The first amount of moisture is associated with the dryer adsorbing moisture (e.g., the first dryer 210 or the second dryer 212). The moisture amount determination module 116 determines the first amount of moisture based at least partially on the inlet moisture content and the conversion efficiency.

Block 409 of the hydrogen mixture analysis process 400 may start in parallel with block 402 or after block 406. At block 409, the moisture amount determination module 116 receives outlet signals from any number of outlet sensors. The outlet signals are associated with a temperature and pressure of the deoxidized and dried hydrogen mixture at the outlet 230. The moisture amount determination module 116 determines an outlet moisture content using a saturation vapor curve based on the outlet signals. At block 410, the moisture amount determination module 116 determines the hydrogen mixture flow rate based on the production rate of the hydrogen mixture. Following determination of the hydrogen mixture flow rate, at block 412, the moisture amount determination module 116 determines the initial amount of moisture stored in the dryer. Following determination of the initial amount of moisture, at blocks 414 and 416, the hydrogen mixture analysis process 400 includes receiving a recycled flow rate and recycled hydrogen signals. The moisture amount determination module 116 determines the recycled hydrogen temperature and the recycled hydrogen pressure based on the recycled hydrogen signals. Based on the recycled hydrogen temperature, pressure, and recycled flow rate, at block 418, the moisture amount determination module 116 determines a recycled hydrogen moisture content.

Following determination of the recycled hydrogen moisture content at block 418 and determination of the conversion efficiency at block 406, the moisture amount determination module 116 determines the first amount of moisture at block 408 using at least one of the hydrogen mixture flow rate, the inlet moisture content, the conversion efficiency, the initial amount of moisture, and the recycled hydrogen moisture content.

Continuing to block 420, the moisture amount determination module 116 determines whether the first amount of moisture is greater than or equal to a threshold. The threshold is stored in the controller 110. In various embodiments, the controller 110 determines the threshold starting at block 422 of the hydrogen mixture analysis process 400. Block 422 can begin in parallel with block 402 or after block 408. At block 422, the threshold determination module 118 determines the regeneration time and the regeneration temperature. The regeneration time and the regeneration temperature can be preset by the user, stored in the controller 110, or based on previous calculations of the first amount of moisture. Continuing to block 424, the threshold determination module 118 determines the age of the dryer based at least partially on the regeneration time. Following determination of the age of the dryer, continuing to block 426, the threshold determination module 118 determines the threshold based on at least one of the regeneration time, the regeneration temperature, and the age of the dryer. For example, the threshold determination module 118 includes a target amount of moisture for the dryer, and adjusts the target amount of moisture based on the age of the dryer. The age of the dryer can affect an ability (e.g., capacity, etc.) of the dryer to regenerate and remove moisture stored up in the dryer. For example, as the age of the dryer increases, an amount of moisture that the dryer can remove (e.g., regenerate, etc.) decreases. The threshold determined by the threshold determination module 118 is stored in the controller 110.

After determining that the first amount of moisture is less than the threshold, the adsorption cycle time determination module 120 determines a regeneration cycle time. To determine the regeneration cycle time, at block 428, the adsorption cycle time determination module 120 determines the adsorption cycle time based on the hydrogen mixture flow rate, the inlet moisture content, the conversion efficiency of the deoxidizer, the initial amount of moisture, and the recycled hydrogen moisture content. The adsorption cycle time is correlated with the first amount of moisture, and the adsorption cycle time may be a predicted length of time at which the first amount of moisture reaches the threshold. Following determination of the adsorption cycle time, at block 430, the adsorption cycle time determination module 120 determines the regeneration cycle time based on the adsorption cycle time after determining that the first amount of moisture is less than the threshold. The regeneration cycle time may be a predicted length of time of the regeneration cycle time based on the adsorption cycle time.

After determining that the first amount of moisture is greater than or equal to the threshold, the controller 110 causes a heater 213 of the dryer to provide heat to the first amount of moisture at block 432. The first amount of moisture is stored in the dryer, and providing heat causes the first amount of moisture to evaporate from the dryer, thereby decreasing a load of the dryer and freeing the dryer to adsorb moisture from the hydrogen mixture once more.

Once the controller 110 starts regeneration of (e.g., providing heat to) the dryer, continuing to block 434, to determine when regeneration is complete, the regeneration determination module 122 receives dryer signals, and determines the dryer inlet temperature and the dryer outlet temperature based on the dryer signals. Following determination of the dryer inlet temperature and the dryer outlet temperature, the regeneration determination module 122 receives chiller signals at block 435, and determines the first chiller temperature and the second chiller temperature based on the chiller signals. Following determination of the first chiller temperature and the second chiller temperature, the regeneration determination module 122 receives the demister level signal and determines the level of water in the demister at block 436. At block 438, the regeneration determination module 122 determines the saturation temperature difference based on the dryer inlet temperature and the dryer outlet temperature. At block 439, the regeneration determination module 122 determines the chiller temperature difference based on the first chiller temperature and the second chiller temperature. Once the saturation temperature difference and the chiller temperature difference are determined, at block 440, the regeneration determination module 122 determines whether regeneration of the dryer is complete.

Continuing to block 442, the hydrogen mixture analysis process 400 includes the regeneration determination module 122 determining a regeneration time difference. The regeneration time difference is indicative of a total length of time of the ongoing regeneration of the dryer. The regeneration determination module 122 determines the regeneration time difference by recording a start time (e.g., initial time value) of the regeneration of the dryer, and comparing the start time to a time of the ongoing regeneration (e.g., first time value). For example, the regeneration determination module 122 starts a time when the heater 213 of the dryer is providing heat to the first amount of moisture in the dryer. Following determination for the regeneration time difference, at block 444, the regeneration determination module 122 compares the regeneration time difference to a regeneration time difference threshold. The regeneration time difference threshold can be preset and indicates a minimum amount of time for the dryer to be regenerating. After determining that the regeneration time difference is less than or equal to the regeneration time difference threshold, the hydrogen mixture analysis process 400 returns to block 442. After determining that the regeneration time difference is greater than the regeneration time difference threshold, the hydrogen mixture analysis process 400 proceeds to block 446.

Taking the dryer outlet temperature and the dryer inlet temperature previously determined at block 434, the regeneration determination module 122 compares the dryer outlet temperature to the dryer inlet temperature. After determining that the dryer outlet temperature is less than the dryer inlet temperature, the hydrogen mixture analysis process 400 returns to block 442. After determining that the dryer outlet temperature is greater than the dryer inlet temperature, the hydrogen mixture analysis process 400 continues to block 448. The dryer outlet temperature being closer (e.g., proximate) to the dryer inlet temperature (e.g., within 25 degrees Celsius of the dryer inlet temperature) indicates that the remains little to no moisture in the dryer to absorb the heat provided by the dryer and evaporate. Consequently, the heat being provided to the dryer increases a temperature of the outlet. In various embodiments, at block 434, the regeneration determination module 122 also compares the dryer inlet temperature to a dryer inlet threshold. The regeneration determination module 122 determines the dryer inlet temperature over time between the initial time and the ongoing time, and determines a percentage of time that the dryer inlet temperature is at a target temperature. The target temperature corresponds to a target temperature of the dryer inlet during regeneration. The hydrogen mixture analysis process 400 continues to block 448 after determining that the percentage of time is greater than the dryer inlet temperature threshold.

Proceeding to block 448, the regeneration determination module 122 receives additional demister level signals. The demister level signals are received at an initial time value when the regeneration determination module 122 begins recording the regeneration and at the time of the ongoing regeneration. Consequently, the regeneration determination module 122 determines an initial level of water and an ongoing level of water within the demister during the regeneration. At block 450, the regeneration determination module 122 determines a difference between the initial level of water and the ongoing level of water, such as by subtracting the initial level of water from the ongoing level of water.

Once the demister level difference is determined, the hydrogen mixture analysis process 400 continues to block 452 with the regeneration determination module 122 determining whether the demister level difference is less than a demister level difference threshold. The demister level difference threshold corresponds to an amount of moisture the demister has accumulated during regeneration, and thus is indicative of an amount of moisture that has been removed from the dryer since the demister separates moisture from gas from the gas stream received by the dryer in regeneration. In various embodiments, the regeneration determination module 122 determines the demister level difference threshold based on the first amount of moisture. For example, the demister level difference threshold is a volumetric value of the first amount of moisture. The demister level difference being less than the demister level difference threshold indicates a minimum amount of moisture accumulated by the demister 226 during regeneration. After determining that the demister level difference is greater than or equal to the demister level difference threshold, the hydrogen mixture analysis process 400 returns to block 448. After determining that the demister level difference is less than the demister level difference threshold, the hydrogen mixture analysis process 400 continues to block 454. In various embodiments, the regeneration determination module 122 also compares the demister level difference to a demister level threshold. The demister level threshold corresponds to the first amount of moisture, and the demister level difference being greater than the demister level threshold indicates that a minimum amount of moisture from the dryer has been received. The hydrogen mixture analysis process 400 thus continues to block 453 after the regeneration determination module 122 determines that the demister level difference is greater than the demister level thresholds.

At block 453, the regeneration determination module 122 determines whether the chiller temperature difference is less than a chiller temperature difference threshold. The chiller temperature difference threshold corresponds to a moisture content of the deoxidized hydrogen mixture. For example, the chiller temperature difference is greater responsive to the moisture content of the deoxidized hydrogen mixture being greater since the second chiller 224 may be chilling both the deoxidized hydrogen mixture and the moisture present in the deoxidized hydrogen mixture. After determining that the chiller temperature difference is less than the chiller temperature difference threshold, the hydrogen mixture analysis process 400 continues to block 454. After determining that the chiller temperature difference is greater than or equal to the chiller temperature difference, the hydrogen mixture analysis process 400 returns to block 448. In various embodiments, the hydrogen mixture analysis process 400 includes either blocks 448, 450, and 452 or block 453. For example, the hydrogen mixture analysis process 400 either determines that the demister level difference is less than a demister level difference threshold at block 452 or that the chiller temperature difference is less than the chiller temperature difference threshold at block 453.

At block 454, the regeneration determination module 122 determines the cycle time difference between the regeneration time difference and the adsorption cycle time. For example, the regeneration determination module 122 compares a difference between a length of time of the regeneration cycle and a length of time of the adsorption cycle. The regeneration cycle time increases as the adsorption cycle time increases as an increase in the adsorption cycle indicates a greater amount of moisture stored in the dryer. At block 456, the regeneration determination module 122 compares the cycle time difference to a cycle time difference threshold. The cycle time difference threshold is indicative of a minimum time difference between the adsorption cycle time and the regeneration time difference to ensure that a length of time of the regeneration cycle corresponds to moisture accumulated in the dryer during the adsorption cycle time. After determining that the cycle time difference is less than or equal to the cycle time difference threshold, the hydrogen mixture analysis process 400 returns to block 454. After determining that the cycle time difference is greater than the cycle time difference threshold, the hydrogen mixture analysis process 400 proceeds to block 458.

At block 458, the controller 110 decreases a temperature of the heater 213 of the dryer. Following determining that the cycle time difference is greater than the cycle time difference threshold at block 458, the regeneration determination module 122 determines that regeneration is complete based on the criteria being met (e.g., cycle time difference is greater than the cycle time difference threshold, etc.), and the controller 110 ends the regeneration cycle of the dryer by decreases the temperature of the heater 213 such that the heater 213 stops providing heat to the dryer.

At blocks 444 and 446, the hydrogen mixture analysis process 400 returns to block 442 while simultaneously continuing to block 460. At block 452, the hydrogen mixture analysis process 400 returns to block 448 while simultaneously continuing to block 460. At block 453, the hydrogen mixture analysis process 400 returns to block 448 while simultaneously continuing to block 460. At block 456, the hydrogen mixture analysis process 400 returns to block 454 while simultaneously continuing to block 460. Following the determinations at blocks 444, 446, 452, 453, and 456, the controller 110 maintains the temperature of the heater 213 of the dryer at block 460. The regeneration determination module 122 determines that regeneration is incomplete based on the criteria not being met (e.g., cycle time difference is less than or equal to the cycle time difference threshold, etc.), and the controller 110 continues the regeneration cycle of the dryer by maintaining the temperature of the heater 213. Following maintenance of the temperature, the hydrogen mixture analysis process 400 proceeds to block 462 where a second count stored by the controller 110 is increased by one by the controller 110. The second count indicates a number of incomplete regenerations. The hydrogen mixture analysis process 400 returns to block 442 after increasing the second count, and the regeneration determination module 122 continues determining whether the regeneration is complete.

Following block 458, the hydrogen mixture analysis process 400 proceeds to block 464 where the controller 110 increases a first count by one. The first count is indicative of a number of complete regenerations. The hydrogen mixture analysis process 400 continues at block 466 with the moisture amount determination module 116 determining a second amount of moisture based on the hydrogen mixture flow rate, the inlet moisture content, the conversion efficiency, the initial amount of moisture, and the recycled hydrogen moisture content. The second amount of moisture corresponds to the initial amount of moisture, and represents an end of regeneration load of the dryer. At least one of the moisture amount determination module 116 and the regeneration determination module 122 stores the second amount of moisture and the cycle time difference at block 468, and the regeneration determination module 122 determines a regeneration efficiency based on the cycle time difference at block 470, the first amount of moisture, and the second amount of moisture. The regeneration determination module 122 determines the regeneration efficiency based on, for example, a difference between the first amount of moisture and the second amount of moisture and the cycle time difference. The cycle time difference is positive when the regeneration time difference is greater than the adsorption cycle time, and negative when the adsorption cycle time is greater than the regeneration time difference. Consequently, the regeneration efficiency decreases when at least one of the cycle time difference increases positively or the difference between the first amount of moisture and the second amount of moisture decreases. In various embodiments, the regeneration determination module 122 substitutes the cycle time difference with the regeneration time difference to determine the regeneration efficiency. Following determination of the regeneration efficiency, the controller 110 stores the regeneration efficiency at block 472.

### V. Overview of an Another Example Hydrogen Mixture Analysis Process

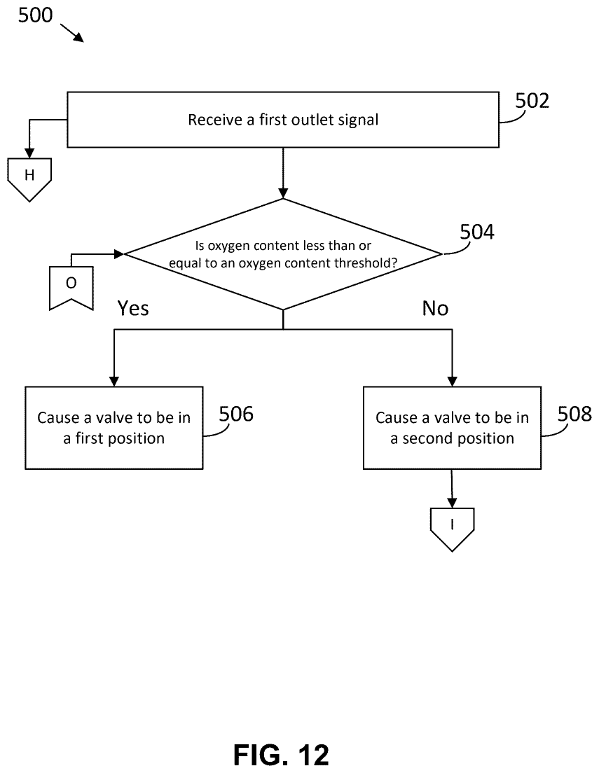

FIGS. 12-15 illustrate an example of the hydrogen mixture analysis process 500 implemented in the system 100. At least one of the hydrogen mixture analysis process 400 and the hydrogen mixture analysis process 500 are implemented by the controller 110, and the controller 110 may implement the hydrogen mixture analysis process 400 and the hydrogen mixture analysis process 500 in parallel or in sequence. The hydrogen mixture analysis process 500 begins at block 502 with receiving at least one outlet signal. The valve control module 124 receives the at least one outlet signal and determines the oxygen content of a portion of the hydrogen mixture based on the at least one outlet signal. The hydrogen mixture reaches the at least one outlet sensor providing the at least one outlet signal via the first flow channel 306.

Once the oxygen content of the hydrogen mixture is determined, the hydrogen mixture analysis process 500 proceeds to block 504 where the valve control module 124 compares the oxygen content to an oxygen content threshold. The oxygen content threshold is indicative of a maximum amount of oxygen content that the resulting deoxidized and dried hydrogen mixture output by the hydrogen purification system 106 can contain. The oxygen content threshold is set by the user, and may differ based on application (e.g., fuel cell, etc.) For example, different users may have different thresholds (e.g., requirements, etc.) for an oxygen content in the deoxidized and dried hydrogen mixture. After determining that the oxygen content is less than or equal to the oxygen content threshold, the hydrogen mixture analysis process 500 proceeds to block 506 where the valve control module 124 causes the valve 302 to be in the first position. Consequently, the hydrogen mixture flows via the second flow channel 308 to the dryer adsorbing moisture and bypasses the deoxidizer. After determining that the oxygen content is greater than the oxygen content threshold, the hydrogen mixture analysis process 500 proceeds to block 508 where the valve control module 124 causes the valve 302 to be in the second position. Consequently, the hydrogen mixture at the inlet 202 flows to the deoxidizer 206 since the oxygen content in the hydrogen mixture exceeds a minimum amount of oxygen acceptable (e.g., desirable, etc.) in the deoxidized and dried hydrogen mixture.

Following block 502, in parallel or sequentially with proceeding to block 504, the hydrogen mixture analysis process 500 proceeds to block 510. In various embodiments, the hydrogen mixture analysis process 500 proceeds to block 510 prior to continuing to block 504. At block 510, the valve control module 124 determine a dew point of the hydrogen mixture. The valve control module 124 determines the dew point based on the at least one outlet signal. Following determination of the dew point, at block 512, the valve control module 124 determines whether the dew point is greater than a dew point threshold. The dew point threshold indicates a maximum amount of moisture content (e.g., moisture level, etc.) in the hydrogen mixture that the first dryer 210 or the second dryer 212 can adsorb such that the deoxidized and dried hydrogen mixture includes minimal to no moisture. Moisture content above the dew point threshold indicates that the hydrogen mixture has too much moisture for the hydrogen purification system 106 to adsorb, and may lead to excessive energy consumption by the hydrogen purification system 106 to remove the moisture in the hydrogen mixture. The minimum amount of moisture in the deoxidized and dried hydrogen mixture may be stored in the controller 110 and preset by the user. In various embodiments, the valve control module 124 determines the dew point threshold based on the minimum amount of moisture.

After determining that the dew point is less than or equal to the dew point threshold, the hydrogen mixture analysis process 500 returns to block 504 to determine the oxygen content. After determining that the dew point is greater than the dew point threshold, the hydrogen mixture analysis process 500 continues to block 514 and the valve control module 124 causes the valve 302 to be in the third position. Consequently, the valve 302 directs the hydrogen mixture through the third flow channel 310 and bypasses the hydrogen purification system 106 and is expelled through the vent 304. The hydrogen mixture expelled through the vent 304 may also be expelled out of the system 100, and is not deoxidized or dried by the hydrogen purification system 106.

After the valve control module 124 causes the valve 302 to be in the second position at block 508, the hydrogen mixture analysis process 500 continues with the deoxidizer target temperature control module 126 determining the deoxidizer target temperature starting at block 516. To determine the deoxidizer target temperature, the deoxidizer target temperature control module 126 receives demister signals at block 516 and determines at least the demister temperature and the demister pressure based on the demister signals. The demister temperature and the demister pressure indicates a temperature and pressure within the demister 226. Proceeding to block 518, the deoxidizer target temperature control module 126 receives inlet signals and determines at least the inlet pressure and the inlet oxygen content. The inlet pressure and the inlet oxygen content indicate a pressure and an oxygen content of the hydrogen mixture at the inlet 202. Proceeding to block 520, the deoxidizer target temperature control module 126 receives a deoxidizer signal and determines at least the deoxidizer pressure based on the deoxidizer signal. The deoxidizer pressure indicates a pressure within the deoxidizer.

Based on the demister pressure and the demister temperature, the deoxidizer target temperature control module 126 determines the demister efficiency at block 522. The deoxidizer target temperature control module 126 estimates the demister efficiency using a saturation vapor curve and determining a water concentration in the demister 226 based on the demister pressure and temperature. Following determination of the demister efficiency, the hydrogen mixture analysis process 500 proceeds to block 524 with the deoxidizer target temperature control module 126 determining an inlet moisture content. The inlet moisture content indicates a moisture content of the hydrogen mixture at the inlet 202, and is determined based on the demister temperature, the demister efficiency, and the inlet pressure. The demister temperature and efficiency indicate an amount of moisture returned to the inlet 202, and the inlet moisture content is further determined by the deoxidizer target temperature control module 126 by inputting the inlet pressure into the ideal gas law. Following determination of the inlet moisture content, the hydrogen mixture analysis process 500 continues to block 526 with the deoxidizer target temperature control module 126 determining the total moisture content based on the inlet moisture content and the inlet oxygen content. The deoxidizer target temperature control module 126 calculates moles of oxygen based on the inlet oxygen content, and adds the moles to the inlet moisture content to determining the total moisture content.

Continuing to block 528, the deoxidizer target temperature control module 126 determines a saturation temperature using the saturation temperature lookup table. The deoxidizer target temperature control module 126 compares the deoxidizer pressure and the total moisture content to the saturation temperature lookup table to determine the saturation temperature. The saturation temperature can be indicative of a saturation temperature of the hydrogen purification system 106. Proceeding to block 530, the deoxidizer target temperature control module 126 determines a deoxidizer target temperature based on a summation of the saturation temperature and a first value associated with an inlet temperature tolerance. The first value indicates a minimum temperature of the deoxidizer target temperature. After determining the deoxidizer target temperature, the controller 110 sets the deoxidizer 206 to the deoxidizer target temperature at block 532.

Following determination of the deoxidizer target temperature, the deoxidizer target temperature control module 126 compares the deoxidizer target temperature to a temperature threshold at block 534. The temperature threshold indicates a maximum temperature the deoxidizer 206 operates at while the deoxidizer target temperature represents the deoxidizer target temperature needed to remove oxygen from the hydrogen mixture. The deoxidizer target temperature being greater than the temperature threshold indicates that the moisture content in the hydrogen mixture is greater than the hydrogen purification system 106 can remove oxygen and moisture from to output deoxidized and dried hydrogen mixture with desirable levels of oxygen and moisture. After determining that the deoxidizer target temperature is greater than the temperature threshold, the hydrogen mixture analysis process 500 returns to block 514, and the valve control module 124 causes the valve 302 to be in the third position to expel the hydrogen mixture to the vent 304.

After determining that the deoxidizer target temperature is less than or equal to the threshold, the hydrogen mixture analysis process 500 continues to block 536 with the saturation temperature determination module 128 determining a target conversion efficiency. The target conversion efficiency is a conversion efficiency of the deoxidizer, and the saturation temperature determination module 128 determines the target conversion efficiency by determining a ratio between the inlet oxygen content and the target oxygen content. The controller stores the target oxygen content of the deoxidized and dried hydrogen mixture which can correspond to the oxygen content threshold. The saturation temperature determination module 128 determines the target conversion efficiency using the recombination reaction of the deoxidizer 206 and the ratio. Following determination of the target conversion efficiency, the saturation temperature determination module 128 receives a velocity signal and determines the velocity of the hydrogen mixture at the inlet 202 at block 538.

After determining the velocity, The saturation temperature determination module 128 determines the saturation temperature of the deoxidized hydrogen mixture based on the velocity and the target conversion efficiency at block 540. After determining the saturation temperature, the saturation temperature determination module 128 determines whether the saturation temperature (e.g., of the deoxidized hydrogen mixture in the dryer) is less than the deoxidizer target temperature at block 542. After determining that the saturation temperature is less than the deoxidizer target temperature, the controller 110 sets the heater 213 to the deoxidizer target temperature at block 544. The deoxidizer target temperature is the temperature of the heater 207. The heater 213 being set to the deoxidizer target temperature prioritizes conversion efficiency of the deoxidizer 206 over power consumption of the heater 213 of the dryer. After determining that saturation temperature is greater than the deoxidizer target temperature, the heater 207 of the deoxidizer 206 is set to the saturation temperature at block 546. The heater 207 being set to the saturation temperature protects the deoxidizer 206 from condensation of moisture in the deoxidizer 206. In various embodiments, the saturation temperature determination module 128 sets the dryer to the lower temperature between the saturation temperature and the deoxidizer target temperature to optimize energy efficiency and power consumption. The saturation temperature determination module 128 sets the temperature of the heater 207 of the deoxidizer 206 to optimize between heater energy efficiency and a deoxidizer 206 condensation protection limit to mitigate deoxidizer 206 damage. The saturation temperature determination module 128 sets the temperature of the heater 213 based on the conversion efficiency of the deoxidizer 206.

### VI. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable, releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A hydrogen purification system comprising:
an electrolyzer configured to produce a hydrogen mixture comprising hydrogen, moisture, and oxygen;
a system inlet configured to receive the hydrogen mixture from the electrolyzer;
a deoxidizer configured to receive the hydrogen mixture from the system inlet and remove at least a portion of the oxygen from the hydrogen mixture;
a dryer configured to receive a deoxidized hydrogen mixture from the deoxidizer and remove at least a portion of the moisture from the deoxidized hydrogen mixture, the dryer comprising a heater;
a system outlet configured to receive a deoxidized and dried hydrogen mixture from the dryer and expel the deoxidized and dried hydrogen mixture;
a first inlet sensor positioned at the system inlet, the first inlet sensor configured to provide a first inlet signal associated with a temperature of the hydrogen mixture at the system inlet;
a second inlet sensor positioned at the system inlet, the second inlet sensor configured to provide a second inlet signal associated with a pressure of the hydrogen mixture at the system inlet; and
a controller configured to:
receive the first inlet signal and the second inlet signal and determine an inlet moisture content and an inlet hydrogen mixture temperature based on the first inlet signal and the second inlet signal,
determine, using a conversion efficiency lookup table, a conversion efficiency of the deoxidizer based on the inlet hydrogen mixture temperature,
determine a first amount of moisture stored in the dryer based on the inlet moisture content and the conversion efficiency, and
after determining that the first amount of moisture is greater than or equal to a threshold, cause the heater to provide heat to the first amount of moisture.

2. The hydrogen purification system of claim 1, further comprising:
a first outlet sensor positioned at the system outlet, the first outlet sensor configured to provide a first outlet signal associated with a temperature of the deoxidized and dried hydrogen mixture at the system outlet; and
a second outlet sensor positioned at the system outlet, the second outlet sensor configured to provide a second outlet signal associated with a pressure of the deoxidized and dried hydrogen mixture at the system outlet;
wherein the controller is further configured to:
receive the first outlet signal and the second outlet signal and determine an outlet moisture content based on the first outlet signal and the second outlet signal,
determine a hydrogen mixture flow rate based on a production rate of the hydrogen mixture by the electrolyzer, and
determine an initial amount of moisture stored in the dryer based on the outlet moisture content prior to receiving the first inlet signal or the second inlet signal; and
wherein the first amount of moisture is determined based on the inlet moisture content, the conversion efficiency, the hydrogen mixture flow rate, and the initial amount of moisture.

3. The hydrogen purification system of claim 2, further comprising:
a chiller configured to receive at least a portion of the deoxidized hydrogen mixture from the dryer while the heater is providing the heat and chill the portion of the deoxidized hydrogen mixture;
a demister configured to receive at least a portion of deoxidized and chilled hydrogen mixture from the chiller and separate recycled hydrogen from the portion of the deoxidized and chilled hydrogen mixture;
a compressor configured to receive at least a portion of the recycled hydrogen from the demister and provide the at least the portion of the recycled hydrogen to at least one of the deoxidizer or the dryer;
a flow meter positioned at the compressor, the flow meter configured to measure a recycled flow rate of the at least the portion of the recycled hydrogen;
a first recycled hydrogen sensor positioned at the compressor, the first recycled hydrogen sensor configured to provide a first recycled hydrogen signal associated with a recycled hydrogen pressure; and
a second recycled hydrogen sensor positioned at the compressor, the second recycled hydrogen sensor configured to provide a second recycled hydrogen signal associated with a recycled hydrogen temperature.

4. The hydrogen purification system of claim 3, wherein the controller is further configured to:
receive the recycled flow rate from the flow meter;
receive the first recycled hydrogen signal from the first recycled hydrogen sensor and determine the recycled hydrogen pressure based on the first recycled hydrogen signal;
receive the second recycled hydrogen signal from the second recycled hydrogen sensor and determine the recycled hydrogen temperature based on the second recycled hydrogen signal;
determine a recycled hydrogen moisture content based on the recycled hydrogen pressure, the recycled hydrogen temperature, and the recycled flow rate of the recycled hydrogen; and
determine the first amount of moisture stored in the dryer based on the hydrogen mixture flow rate, the inlet moisture content, the conversion efficiency, the initial amount of moisture, and the recycled hydrogen moisture content.

5. The hydrogen purification system of claim 4, wherein the controller is further configured to:
determine an adsorption cycle time of the dryer based on the hydrogen mixture flow rate, the inlet moisture content, the conversion efficiency of the deoxidizer, the initial amount of moisture, and the recycled hydrogen moisture content; and
after determining that the first amount of moisture is less than the threshold, determine a regeneration cycle time based on the adsorption cycle time.

6. The hydrogen purification system of claim 5, wherein:
the dryer comprises:
a dryer inlet configured to receive the deoxidized hydrogen mixture from the deoxidizer,
a dryer outlet configured to expel the deoxidized and dried hydrogen mixture,
a first dryer sensor positioned at the dryer inlet configured to provide a first dryer signal associated with a dryer inlet temperature, and
a second dryer sensor positioned at the dryer outlet configured to provide a second dryer signal associated with a dryer outlet temperature;
the chiller comprises:
a first chiller sensor located at the chiller, the first chiller sensor configured to provide a first chiller signal associated with a temperature of the portion of the deoxidized hydrogen mixture; and
a second chiller sensor located at the chiller, the second chiller sensor configured to provide a second chiller signal associated with a temperature of the portion of the deoxidized and chilled hydrogen mixture; and
the demister comprises a demister sensor located in the demister, the demister sensor configured to provide a demister level signal associated with a level of water in the demister.

7. The hydrogen purification system of claim 6, wherein the controller is further configured to:
receive the first dryer signal and determine the dryer inlet temperature based on the first dryer signal;
receive the second dryer signal and determine the dryer outlet temperature based on the second dryer signal;
receive the first chiller signal and determine a first chiller temperature of the portion of the deoxidized hydrogen mixture based on the first chiller signal;
receive the second chiller signal and determine a second chiller temperature of the portion of the deoxidized and chilled hydrogen mixture based on the second chiller signal;
receive the demister level signal and determine the level of water in the demister based on the demister level signal;
determine a saturation temperature difference based on the dryer inlet temperature and the dryer outlet temperature;
determine a chiller temperature difference based on the first chiller temperature and the second chiller temperature; and
determine whether regeneration of the dryer is complete based on at least one of the adsorption cycle time, the saturation temperature difference, the chiller temperature difference, the level of water in the demister, the hydrogen mixture flow rate, or the first amount of moisture.

8. The hydrogen purification system of claim 7, wherein to determine whether regeneration of the dryer is complete, the controller is further configured to:
determine a regeneration time difference between an initial time value corresponding to a start of the regeneration and a first time value corresponding to an ongoing regeneration;
compare the regeneration time difference to a regeneration time threshold;
determine whether the dryer outlet temperature is proximate to the dryer inlet temperature;
compare the chiller temperature difference to a chiller temperature difference threshold;
receive the demister level signal at the initial time value and determine an initial level of water in the demister based on the demister level signal;
receive the demister level signal at the first time value and determine a first level of water in the demister based on the demister level signal;
determine a demister level difference based on the initial level of water and the first level of water;
compare the demister level difference to a demister level difference threshold;
determine a cycle time difference based on a difference between the regeneration time difference and the adsorption cycle time;
compare the cycle time difference to a cycle time difference threshold; and
after determining that the regeneration time difference is greater than the regeneration time threshold, the demister level difference is less than the demister level difference threshold, the dryer outlet temperature is greater than the dryer inlet temperature, the chiller temperature difference is less than the chiller temperature difference threshold, and the cycle time difference is greater than the cycle time difference threshold, determine that regeneration is complete and decrease the temperature of the heater to initiate adsorption of the dryer.

9. The hydrogen purification system of claim 8, wherein after determining that at least one of the regeneration time difference is less than or equal to the regeneration time threshold, the demister level difference is greater than or equal to the demister level difference threshold, the dryer outlet temperature is less than the dryer inlet temperature, the chiller temperature difference is greater than or equal to the chiller temperature difference threshold, or the cycle time difference is less than or equal to the cycle time difference threshold, determine that regeneration is incomplete and maintaining the temperature of the heater to continue regeneration of the dryer.

10. The hydrogen purification system of claim 9, wherein:
the controller stores a first count associated with a complete regeneration and a second count associated with an incomplete regeneration; and
the controller is further configured to:
after determining that the regeneration is incomplete, increase the second count by one, and
after determining that the regeneration is complete,
increase the first count by one,
determine a second amount of moisture stored in the dryer based on the hydrogen mixture flow rate, the inlet moisture content, the conversion efficiency, the initial amount of moisture, and the recycled hydrogen moisture content;
store the second amount of moisture and the cycle time difference,
determine a regeneration efficiency based on the cycle time difference, the first amount of moisture, and the second amount of moisture, and
store the regeneration efficiency.

11. The hydrogen purification system of claim 1, wherein the controller is further configured to determine the threshold by:
determining a regeneration time and a regeneration temperature for regeneration of the dryer;
determining an age of the dryer based on the regeneration time; and
determining the threshold based on the regeneration time, the regeneration temperature, and the age of the dryer.

12. A system comprising:
an electrolyzer configured to produce a hydrogen mixture comprising hydrogen, moisture, and oxygen;
a hydrogen purification system configured to remove at least a portion of moisture and oxygen from the hydrogen mixture, the hydrogen purification system comprising:
an inlet configured to receive the hydrogen mixture from the electrolyzer,
a deoxidizer configured to receive the hydrogen mixture from the inlet and remove at least a portion of the oxygen from the hydrogen mixture,
a dryer configured to receive a deoxidized hydrogen mixture from the deoxidizer and remove at least a portion of the moisture from the at least the deoxidized hydrogen mixture,
an outlet configured to receive at least a deoxidized and dried hydrogen mixture from the dryer and expel the deoxidized and dried hydrogen mixture,
a first outlet sensor positioned closer to the outlet than the inlet, the first outlet sensor configured to provide a first outlet signal associated with at least one of an oxygen content or a dew point of a portion of the hydrogen mixture, and
a valve operable between a first position and a second position, the valve configured to facilitate flow of the hydrogen mixture to the dryer in the first position, the valve configured to facilitate the flow of the hydrogen mixture to the deoxidizer in the second position; and
a controller configured to:
receive the first outlet signal and determine the oxygen content based on the first outlet signal,
compare the oxygen content to an oxygen content threshold,
after determining that the oxygen content is less than or equal to the oxygen content threshold, causing the valve to be in the first position, and
after determining that the oxygen content is greater than the oxygen content threshold, causing the valve to be in the second position.

13. The system of claim 12, further comprising a vent configured to expel the hydrogen mixture located upstream of the deoxidizer;
wherein the valve is operable between the first position, the second position, and a third position, the valve configured to facilitate the flow of the hydrogen mixture to the vent in the third position;
wherein the controller is further configured to:
receive the first outlet signal and determine the dew point based on the first outlet signal, and
after determining that the dew point is greater than a dew point threshold, cause the valve to be in the third position.

14. The system of claim 13, wherein:
the hydrogen purification system further comprises:
a demister configured to receive a portion of the deoxidized hydrogen mixture from the dryer and separate moisture and hydrogen from the portion of the deoxidized hydrogen mixture,
a first demister sensor positioned at the demister, the first demister sensor configured to provide a first demister signal associated with a demister temperature, and
a second demister sensor positioned downstream of the demister, the second demister sensor configured to provide a second demister signal associated with a demister pressure; and
the controller is further configured to:
receive the first demister signal and determine the demister temperature based on the first demister signal after causing the valve to be in the second position, and
receive the second demister signal and determine the demister pressure based on the second demister signal.

15. The system of claim 14, wherein:
the hydrogen purification system further comprises:
a first inlet sensor positioned at the inlet, the first inlet sensor configured to provide a first inlet signal associated with a pressure of the hydrogen mixture at the inlet,
a second inlet sensor positioned at the inlet, the second inlet sensor configured to provide a second inlet signal associated with an oxygen content of the hydrogen mixture at the inlet, and
a deoxidizer sensor positioned at the deoxidizer, the deoxidizer sensor configured to provide a deoxidizer signal associated with a deoxidizer pressure; and
the controller is further configured to:
receive the first inlet signal and determine an inlet pressure based on the first inlet signal,
receive the second inlet signal and determine an inlet oxygen content based on the second inlet signal, and
receive the deoxidizer signal and determine the deoxidizer pressure based on the deoxidizer signal.

16. The system of claim 15, wherein the controller is further configured to:
determine a demister efficiency based on the demister pressure and the demister temperature;
determine an inlet moisture content based on the demister temperature, the demister efficiency, and the inlet pressure;
determine a total moisture content based on the inlet moisture content and the inlet oxygen content;
determine a saturation temperature, using a saturation temperature lookup table, based on the total moisture content and the deoxidizer pressure;
determine a deoxidizer target temperature based on a summation of the saturation temperature and a first value associated with an inlet temperature tolerance; and
set the deoxidizer to the deoxidizer target temperature.

17. The system of claim 16, wherein:
the dryer further comprises a heater to provide heat to moisture stored in the dryer;
the hydrogen purification system further comprises a volumetric flow rate sensor positioned at the inlet, the volumetric flow rate sensor configured to provide a velocity signal associated with a velocity of the hydrogen mixture; and
the controller stores a target oxygen content of the deoxidized and dried hydrogen mixture, the controller further configured to:
determine a target conversion efficiency of the deoxidizer by determining a ratio between the inlet oxygen content and the target oxygen content,
receive the velocity signal and determine the velocity of the hydrogen mixture based on the velocity signal,
determine, using an inlet temperature lookup table, a saturation temperature of the deoxidized hydrogen mixture based on the velocity and the target conversion efficiency,
after determining that the saturation temperature is less than the deoxidizer target temperature, set the heater to the deoxidizer target temperature, and
after determining that the deoxidizer target temperature is less than the saturation temperature, set the heater to the saturation temperature.

18. The system of claim 16, wherein the controller is further configured to cause the valve to be in the third position after determining that the deoxidizer target temperature is greater than a temperature threshold.

19. The system of claim 16, wherein the controller is further configured to determine at least one of an adsorption cycle time or a regeneration cycle time based on the total moisture content.

20. The system of claim 12, further comprising a flow channel fluidically coupled to the inlet and the first outlet sensor, the flow channel configured to deliver the portion of the hydrogen mixture to the first outlet sensor for the first outlet sensor to provide the first outlet signal.
